(19) United States
(12) Patent Application Publication
(10) Pub. No.: US 2023/0212005 A1
(43) Pub. Date: Jul. 6, 2023

(54) HYDROGEN STORAGE DEVICE

(71) Applicant: H2GO POWER LTD, London (GB)

(72) Inventors: Luke SPERRIN, London (GB); Enass ABO HAMED, London (GB); Peter ITALIANO, London (GB)

(21) Appl. No.: 17/906,805

(22) PCT Filed: Mar. 26, 2021
(86) PCT No.: PCT/GB2021/050758

§ 371 Date: Sep. 20, 2022

(30) Foreign Application Priority Data
Mar. 26, 2020 (GB) 2004425.1

(51) Int. Cl. C01B 3/00; F17C 11/00

(52) U.S. Cl. CPC C01B 3/0015; F17C 11/005; F17C 2221/012; F17C 2201/0147

(57) ABSTRACT

A hydrogen storage device 200 comprises: a first vessel 230, having a first fluid inlet 210 and/or a first fluid outlet 220, having therein a thermally conducting network 240 thermally coupled to a first heater (not shown); wherein the first vessel 230 is arranged to receive therein a hydrogen storage material in thermal contact, at least in part, with the thermally conducting network 240; wherein the thermally conducting network 240 has a lattice geometry, a gyroidal geometry and/or a fractal geometry in two and/or three dimensions, comprising a plurality of nodes, having thermally conducting arms therebetween, with voids between the arms; and wherein the hydrogen storage material comprises and/or is a liquid organic hydrogen carrier, LOHC.

### FIELD

The present invention relates to hydrogen storage devices.

### BACKGROUND TO THE INVENTION

Hydrogen is an environmentally-attractive alternative fuel to fossil fuels. Importantly, hydrogen can be produced without the use of fossil fuels, such as by the electrolysis of water using renewable energy. Hydrogen has a relatively high density of energy per unit mass and is effectively non-polluting since the main combustion product is water.

While hydrogen has wide potential application as a fuel, a major drawback in its utilization has been lack of suitable storage. Conventionally, hydrogen is stored in a first vessel as a compressed gas under a high pressure or stored as a cryogenic liquid, being cooled to an extremely low temperature. However, storage of hydrogen as a compressed gas generally involves use of large first vessels, limiting deployment at, for example, remote sites. Further, liquid hydrogen is expensive to produce while storage of hydrogen as a liquid presents a serious safety problem and requires storage below 20 K, thus precluding use in temporary installations, for example. Furthermore, scalability of storage, using conventional pressure first vessels or liquid hydrogen, is limited by the associated infrastructure requirements, as mandated by safety and/or cost.

Hence, there is a need to improve storage of hydrogen.

### SUMMARY OF THE INVENTION

It is one aim of the present invention, amongst others, to provide a hydrogen storage device which at least partially obviates or mitigates at least some of the disadvantages of the prior art, whether identified herein or elsewhere. For instance, it is an aim of embodiments of the invention to provide a hydrogen storage device having an enhanced storage capacity, compared with conventional storage of hydrogen. For instance, it is an aim of embodiments of the invention to provide a hydrogen storage device having improved safety, compared with conventional hydrogen storage. For instance, it is an aim of embodiments of the invention to provide a hydrogen storage device having improved control for charging and/or release of hydrogen.

A first aspect provides a hydrogen storage device comprising: a first vessel, having a first fluid inlet and/or a first fluid outlet, having therein a thermally conducting network thermally coupled to a first heater; wherein the first vessel is arranged to receive therein a hydrogen storage material in thermal contact, at least in part, with the thermally conducting network; wherein the thermally conducting network has a lattice geometry, a gyroidal geometry and/or a fractal geometry in two and/or three dimensions, comprising a plurality of nodes, having thermally conducting arms therebetween, with voids between the arms; and wherein the hydrogen storage material comprises and/or is a liquid organic hydrogen carrier, LOHC.

A second aspect provides a method of storing hydrogen comprising passing hydrogen gas into a hydrogen storage device according to the first aspect, comprising heating and optionally cooling the thermally conducting network.

A third aspect provides a method of providing hydrogen comprising releasing hydrogen gas from a hydrogen storage device according to the first aspect, comprising heating the thermally conducting network.

### DETAILED DESCRIPTION OF THE INVENTION

According to the present invention there is provided a hydrogen storage device, as set forth in the appended claims. Also provided is a method of charging a hydrogen storage device and a method of releasing hydrogen from a hydrogen storage device. Other features of the invention will be apparent from the dependent claims, and the description that follows.

### Hydrogen Storage Device

The first aspect provides a hydrogen storage device comprising: a first vessel, having a first fluid inlet and/or a first fluid outlet, having therein a thermally conducting network thermally coupled to a first heater; wherein the first vessel is arranged to receive therein a hydrogen storage material in thermal contact, at least in part, with the thermally conducting network; wherein the thermally conducting network has a lattice geometry, a gyroidal geometry and/or a fractal geometry in two and/or three dimensions, comprising a plurality of nodes, having thermally conducting arms therebetween, with voids between the arms; and wherein the hydrogen storage material comprises and/or is a liquid organic hydrogen carrier, LOHC.

In this way, control for charging and/or release (also known as hydrogenation or loading and dehydrogenation or unloading, respectively) of hydrogen from the hydrogen storage material is improved because the flow of heat through the thermally conducting network provides for faster, more homogenous, more accurate and/or more precise heating and optionally cooling of the hydrogen storage material in thermal contact therewith. In this way, release of hydrogen is with less delay or lag time, thereby providing hydrogen more responsively, for example in response to a demand. Conversely, storage of hydrogen is more efficient, allowing faster mass or volume flow of the hydrogen storage material through the hydrogen storage device due to improved cooling and thus control of reaction temperature.

In one example, the hydrogen storage device comprises and/or is a static hydrogen storage device. In such a static device, a predetermined volume of LOHC (for example, corresponding with at most an open volume of the first vessel) is received in the first vessel through the first fluid inlet and heated, via the thermally conducting network, thereby releasing hydrogen gas, which exits the first vessel via the first fluid outlet. When all the hydrogen is released from the LOHC, only liquid organic carrier, LOC, (i.e. unloaded LOHC) remains in the first vessel, and may be discharged (for example, for reloading) via the first fluid outlet or reloaded in the first vessel. Alternatively, in such a static device, a predetermined volume of liquid organic carrier, LOC, is received in the first vessel through the first fluid inlet together with hydrogen gas and heated and optionally cooled, via the thermally conducting network, thereby storing the hydrogen gas in the LOC as the LOHC. When the LOC is fully loaded, only loaded LOHC remains in the first vessel. Hence, it should be understood that in the static device, the LOHC (or LOC) does not flow through the first vessel while releasing (or charging, respectively) the hydrogen. In one example, the static hydrogen storage device comprises a mixer or stirrer, for mixing or stirring the LOHC (or LOC) therein, thereby improving an efficiency of dehydrogenation (or hydrogenation), respectively.

In contrast, in one example, the hydrogen storage device comprises and/or is a dynamic (also known as flow-through) hydrogen storage device. In such a dynamic device, a flow of LOHC is received, for example continuously, into the first vessel through the first fluid inlet and heated, via the thermally conducting network, thereby releasing hydrogen gas, which exits the first vessel together with the LOC (i.e. the unloaded LOHC) through the first fluid outlet. Alternatively, in such a dynamic device, a flow of LOC is received in the first vessel together with a pressurised flow of hydrogen gas and heated and optionally cooled, via the thermally conducting network, thereby storing the hydrogen gas in the loaded LOC as the LOHC, which exits the first vessel through the first fluid outlet. Hence, it should be understood that in the dynamic device, the LOHC (or LOC) flows through the first vessel while releasing (or charging, respectively) the hydrogen. In one example, the hydrogen storage device comprises a pump arranged to flow the hydrogen storage material through the first vessel.

It should be understood that during hydrogenation and dehydrogenation, there is thus generally a mixture of LOC and LOHC in the vessel, except initially and at completion (if completion achieved) of the reaction.

In one example, the hydrogen storage device comprises, is and/or is known as a reactor. In one example, the hydrogen storage device comprises, is and/or is known as a dehydrogenation reactor, for dehydrogenation of the LOHC. In one example, the hydrogen storage device comprises, is and/or is known as a hydrogenation reactor, for hydrogenation of the LOC. Specific requirements for these two reactors will be apparent from the context.

Applications for the hydrogen storage device include providing hydrogen for a fuel cell, such as onboard a vehicle (including land craft, sea craft and air craft including drones) and for electricity generation such as at remote sites, amongst others.

### First Vessel

The hydrogen storage device comprises the first vessel, having the first fluid inlet and/or the first fluid outlet. In contrast to conventional pressure first vessels for storage of compressed hydrogen gas, the first vessel is designed according to a relatively low operating pressure of at most 10 bar, preferably at most 7.5 bar, more preferably at most 5 bar, even more preferably at most 2.5 bar, particularly for dehydrogenation while hydrogenation may be performed at higher pressures such as 10 bar, 20 bar, 50 bar or even 100 bar. Generally, a conventional pressure first vessel for high pressure storage of hydrogen (i.e. 350 bar to 700 bar) is cylindrical, having dished ends. In contrast, since the first vessel is designed according to a relatively low operating pressure, a shape of the first vessel may be varied, while still maintaining an integrity and/or safety factor thereof. For example, the first vessel may be cuboidal such as a square based prism, thereby increasing space utilisation and/or enabling stacking thereof. For example, the first vessel may be shaped aerodynamically (for example, for aircraft and land craft) or hydrodynamically (for water craft). In one example, the hydrogen storage device, for example the first vessel, has at most two planes of symmetry, preferably having a shape arranged to reduce drag (i.e. shaped aerodynamically or hydrodynamically), in use. In one example, the first vessel has a moment of inertia I>½MR² about its central axis, where M is the mass of the first vessel and R is the mean radius of the first vessel, normal to the central axis. It should be understood that the moment of inertia I is determined for the empty first vessel shell i.e. not including the thermally conducting network, the hydrogen storage material, hydrogen, the first inlet and the first outlet. In one example, the first vessel comprises an insulating layer, arranged to thermally insulate the first vessel. In this way, control of a temperature of the first vessel is improved. In one example, the first vessel comprises a double wall (i.e. an inner pressure wall and an outer wall, for example an outer skin). In this way, a gap between the double wall may provide an insulating layer and/or comprise an insulating layer. In one example, the outer wall may be shaped aerodynamically or hydrodynamically and/or the inner wall is cylindrical, having dished ends. In this way, a wall thickness of the inner wall may be reduced for a given operating pressure, while the outer wall reduces drag. In addition, the outer wall may provide a physical buffer, reducing damage to the inner wall. In one example, the first vessel comprises a passageway arranged, for example axially, to receive the first heater therein. In one example, the passageway is a blind passageway. In one example, the passageway is a through passageway. In one example, the first heater comprises a Joule heater, for example a cartridge heater, and/or a recirculating heater, for example recirculating liquid, and the first vessel is arranged, for example comprising a passageway, to interchangeably receive the Joule heater and the recirculating heater therein and/or thereon. For example, the first vessel may comprise a through passageway, arranged to receive a cartridge heater inserted therein through an end of the passageway and the opposed end of the passageway may be closed, for example with an insulating plug. Alternatively, the cartridge heater and the plug may be removed and fluid couplings instead fitted to the ends, such that a recirculating liquid, such as heated coolant (i.e. a heating fluid) from a fuel cell to heat the thermally conducting network, may be pumped therethrough. In this way, flexibility for heating and/or cooling the thermally conducting network is provided. In one example, the hydrogen storage device comprises a passageway, wherein the hydrogen storage device is arrangeable in: a first configuration to receive a Joule heater in the passageway; and a second configuration to receive a flow of a liquid through the passageway.

It should be understood that the first fluid inlet and the first fluid outlet are for the inlet of LOHC or LOC and hydrogen into the first vessel (for unloading and loading, respectively) and outlet of hydrogen and LOC or LOHC from the first vessel (for unloading and loading, respectively), respectively, such as provided, at least in part, by a perforation (i.e. an aperture, a passageway, a hole) through a wall of the first vessel. In one example, the first fluid inlet and the first fluid outlet are provided by and/or via the same inlet, for example for a static hydrogen storage device. In one example, the first fluid inlet and the first fluid outlet are mutually spaced apart at opposed ends of the first vessel, thereby defining, at least in part, a path for flow of the hydrogen storage material and/or hydrogen therebetween, for example via the voids of the thermally conducting network. In one example, the first vessel has a plurality of gas inlets and/or gas outlets, including the first gas inlet and the first gas outlet respectively. In one example, the first fluid inlet and the first fluid outlet comprise releasable couplings, thereby providing coupling thereto and uncoupling therefrom, for example repeatedly, of corresponding couplings. Suitable releasable couplings (also known as fittings or connectors) include push-fit fittings, bayonet fittings, quick connect fittings, cylinder connections to BS341 or DIN 477, hose end fittings, pipe end fittings, tube end fittings and screw fittings. Other releasable couplings are known. In one example, the hydrogen storage device comprises one or more of a thermocouple, a thermowell, a valve, a flashback arrestor, a filter such as a sorbent protection filter, a pressure sensor and a mass flow controller (MFC), for example inline with the first releasable fluid inlet coupling. A valve is generally movable between an open position in which hydrogen can enter or exit the first vessel, and a closed position in which the first vessel is sealed. In one example, the valve is electrically and/or pneumatically actuatable. In this way, the valve may be actuated remotely, for example via a controller. In one example, the MFC is electrically actuatable. In this way, the MFC may be actuated remotely, for example via a controller, to control flow of hydrogen therethrough. In one example, the first vessel comprises means for compressing, for example uniaxially, biaxially, triaxially or hydrostatically, the hydrogen storage material therein. In this way, thermal contact within the hydrogen storage material and/or between the hydrogen storage material and the thermally conducting network may be improved.

In one example, the hydrogen storage device comprises a set of vessels including the first vessel, for example arranged in parallel and/or in series. In this way, a throughput of hydrogenation and/or dehydrogenation may be increased. In one example, the set of vessels includes N vessels, wherein N is a natural number greater than or equal to 1, for example 1, 2, 3, 4, 5, 6, 7, 8, 9, 10 or more.

### Thermally Conducting Network

The first vessel comprises therein the thermally conducting network thermally coupled to the first heater. In one example, a face of the thermally conducting network is in thermal contact (and hence thermally coupled to) the first heater. In one example, the first heater is integrally formed with and/or in the thermally conducting network, at least in part. For example, the first heater may be embedded within (i.e. internal to) the thermally conducting network.

The thermally conducting network may be formed from any suitable thermally conducting material for example a metal such as aluminium, copper, respective alloys thereof such as brass or bronze alloys of copper and/or stainless steel. Preferred materials also do not react with and/or are not embrittled by hydrogen and/or the hydrogen storage material, while having sufficient strength to maintain a structural integrity of the thermally conducting network. In one example, the thermally conducting network comprises a coating to reduce reaction with and/or embrittlement by hydrogen.

The thermally conducting network has the lattice geometry, the gyroidal geometry and/or the fractal geometry in two and/or three dimensions, comprising the plurality of nodes, having the thermally conducting arms therebetween, with voids between the arms. It should be understood that gyroidal geometries are generally in three dimensions. Hence, it should be understood that the thermally conducting network has the lattice geometry and/or the fractal geometry in two and/or three dimensions and/or the gyroidal geometry in three dimensions, comprising the plurality of nodes, having the thermally conducting arms therebetween, with voids between the arms. It should be understood that such geometries comprise a plurality of nodes, having thermally conducting arms (i.e. generally elongated members) therebetween, with voids (i.e. gaps, space) between the arms. It should be understood the voids are interconnected, thereby defining, at least in part, a path for flow of the hydrogen storage material and/or hydrogen therethrough. Such geometries, particularly the fractal geometry and the gyroidal geometry, provide relatively high surface area to volume ratios, enabling especially efficient heat transfer to and from the hydrogen storage material. In one example, the fractal geometry is selected from a group consisting of a Gosper Island, a 3D H-fractal, a Quadratic Koch Island, a Quadratic Koch surface, a Von Koch surface, a Koch Snowflake, a Sierpinski carpet, a Sierpinski tetrahedron, a Mandelbox, a Mandelbulb, a Dodecahedron fractal, a Icosahedron fractal, a Octahedron fractal, a Menger sponge and a Jerusalem cube. Certain fractal geometries, such as Gosper islands, allow for a plurality of individual repeat unit blocks to be fabricated and then assembled together in a tessellation (i.e. assembled together with no overlaps or gaps). This enables a plurality of channels to be provided in the thermally conducting network through the hydrogen storage device, whereby each channel has a high surface area, is of the same construction but does not leave wasted space between repeat units. A gyroid is an infinitely connected triply periodic minimal surface, similar to the lidnoid which is also within the scope of the first aspect. The gyroid separates space into two oppositely congruent labyrinths of passages, through which the hydrogen storage material may flow. In one example, an effective density (also known as lattice volume ratio) of the lattice geometry is uniform in one, two or three dimensions (i.e. mutually orthogonal dimensions). In one example, an effective density of the lattice geometry is non-uniform in one, two or three dimensions (i.e. mutually orthogonal dimensions). It should be understood that a uniform effective density in a particular dimension provides a constant void fraction, between arms of the lattice geometry, in the particular dimension. Conversely, it should be understood that a non-uniform effective density in a particular dimension provides a non-constant void fraction, between arms of the lattice geometry, in the particular dimension. A higher effective density will lead to faster heat conduction due to a higher thermally conducting material content. For example, the effective density may increase or decrease in the particular dimension, for example radially. In this way, the thermally conducting network may be designed, for example optimised, for a particular first vessel geometry so as to improve, for example optimise, heat transfer to and/or from the hydrogen storage material via the thermally conducting network. In one example, an effective density of the lattice geometry is uniform in a first dimension, for example axially, and non-uniform in mutually orthogonal second and third dimensions, for example radially. While the surface area to volume ratios of lattice geometries, for example square lattice geometries such as three-dimensional cages, are relatively lower than of fractal geometries having the same volumes, forming and/or fabrication of lattice geometries is relatively less complex and/or costly and hence may be preferred. In one example, the lattice geometry is Bravais lattice for example a triclinic lattice such a primitive triclinic lattice; a monoclinic lattice such as a primitive triclinic lattice or a base-centred triclinic lattice; an orthorhombic lattice such as a primitive orthorhombic lattice a base-centred orthorhombic lattice, a body-centred orthorhombic lattice or a face-centred orthorhombic lattice; a tetragonal lattice such as a primitive tetragonal lattice or a body-centred tetragonal lattice; a hexagonal lattice such as a primitive hexagonal lattice or a rhombohedral primitive lattice; or a cubic lattice such as a primitive cubic lattice, a body-centred cubic lattice or a face-centred cubic lattice. Other lattices are known. Hence, these Bravais lattices, for example define a plurality of regularly-arranged nodes having thermally conducting arms therebetween. In one example, the thermally conducting arms have a cross sectional dimension (for example a diameter or a width) in a range from 0.1 mm to 10 mm, preferably in a range from 0.25 mm to 5 mm, more preferably in a range from 0.5 mm to 2.5 mm and/or a length in range from 0.5 mm to 50 mm, preferably in a range from 1 mm to 25 mm, more preferably in a range from 2 mm to 10 mm. In this way, heat transfer of the thermally conducting network may be controlled by selecting an effective density and/or a surface area of the thermally conducting network.

In one example, the thermally conducting network is formed, at least in part, by 3D printing (i.e. additive manufacturing), for example by selective laser melting (SLM), thereby enabling forming of complex shapes in three dimensions having internal voids, for example. In one example, the thermally conducting network is formed, at least in part, by casting such as investment casting, moulding such as injection moulding and extrusion. Other additive manufacturing processes are known. In one example, the thermally conducting network is formed, at least in part, by fabrication and/or machining such as milling, turning or drilling. Other subtractive manufacturing processes are known.

In one example, the thermally conducting network comprises fluidically interconnected passageways therein, for example within the arms and/or the nodes thereof, for flow therethough of a fluid, such as a heating fluid and/or a coolant, preferably a liquid for example a recirculating liquid. In this way, heating and/or cooling of the thermally conducting network may be accelerated. Hence, control for charging and/or release of hydrogen from the hydrogen storage device is improved because the flow of the fluid through the interconnected passageways in the thermally conducting network provides for faster, more homogenous, more accurate and/or more precise heating of the thermally conducting network and in turn, the hydrogen storage material in thermal contact therewith. Additionally and/or alternatively, in this way, storing and/or release of the hydrogen may be accelerated since heat required may be provided by the flow of the fluid through the interconnected passageways in the thermally conducting network.

It should be understood that the fluidically interconnected passageways are within, for example wholly within, the thermally conducting network, for example within the arms and/or the nodes thereof, such that at least some of the arms and/or the nodes thereof are tubular (i.e. having lumens therein) or shells (i.e. having cavities therein, hollow), respectively. That is, the passageways are internal to the thermally conducting network. In contrast, the voids (i.e. gaps, space) between the arms, as described above, are external to the thermally conducting network. In one example, at least some of the arms comprise tubular arms and/or at least some of the nodes comprise shells. In one example, walls of the arms and/or the nodes comprise no perforations therethrough. In this way, leakage of the fluid from the fluidically interconnected passageways is prevented and/or escape of hydrogen into the fluidically interconnected passageways is prevented. In one example, a wall thickness of the arms and/or the nodes is in a range from 0.01 mm to 5 mm, preferably in a range from 0.1 mm to 2.5 mm, more preferably in a range from 0.25 mm to 1.5 mm. In one example, the fluidically interconnected passageways define a flowpath (for example, a single flowpath) or a plurality of flowpaths (for example, parallel flowpaths), for example for recirculation of the fluid. In one example, the fluidically interconnected passageways define a capillary flowpath. In one example, the nodes provide bifurcations for the flow. In one example, the fluid is a liquid, selected for compatibility with a material of the thermally conducting network. The liquid may include one or more additives, such as corrosion inhibitors, to enhance compatibility with the material. For example, the liquid may be water, optionally comprising one or more corrosion inhibitor. In one example, surfaces of the fluidically interconnected passageways comprise a coating, for example to inhibit corrosion of the material of the thermally conducting network. In one example, the hydrogen storage device comprises a pump for pumping the fluid through the fluidically interconnected passageways. In one example, the hydrogen storage comprises a reservoir for the fluid, fluidically coupled to the fluidically interconnected passageways and optionally the pump. In one example, the first heater is arranged to heat the fluid. In one example, a first cooler is arranged to cool the fluid.

In one example, the hydrogen storage device for example the first vessel or a part thereof such as the thermally conducting network comprises a LOHC hydrogenation and/or dehydrogenation catalyst, for example provided on and/or in a surface thereof. Catalysts for hydrogenation and dehydrogenation are known, typically first, second and/or third row transition metals on supports. The relatively large surface area to volume ratio provided by the thermally conducting network provides a relatively large surface area for the catalyst while also effectively transferring heat to the hydrogen storage material. In one example, the catalysts are provided on and/or in the surface of the thermally conducting network in a range from 50% to 99%, preferably in a range from 75% to 97.5%, more preferably in a range from 85% to 95%, by area of the surface of the thermally conducting network.

In one example, the thermally conducting network has a porosity in a range from 50% to 99%, preferably in a range from 75% to 97.5%, more preferably in a range from 85% to 95%, by volume of the thermally conducting network. It should be understood that the porosity is due, at least in part, to the voids between the arms. It should be understood that the porosity is interconnected, thereby defining, at least in part, a path for flow of the hydrogen storage material and/or hydrogen therethrough. Particularly, the relatively high porosity of the thermally conducting network improves heat transfer to the hydrogen storage material due, at least in part, to the relatively high surface area thus exposed thereto. In one example, the arms and/or the nodes of the thermally conducting network comprise interconnected pores, thereby defining, at least in part, a path for flow of the hydrogen storage material and/or hydrogen therethrough and thereby further increasing the exposed surface area of the thermally conducting network.

In one example, the thermally conducting network has a specific surface area in a range from 0.1 m⁻¹ to 100 m⁻¹, preferably in a range from 0.5 m⁻¹ to 50 m⁻¹, more preferably in a range from 1 m⁻¹ to 10 m⁻¹. It should be understood that the specific surface area is the exposed surface area of the thermally conducting network per unit volume. Particularly, the relatively high specific surface area of the thermally conducting network improves heat transfer to the hydrogen storage material due, at least in part, to the relatively high surface area thus exposed thereto.

### Dopant

In one example, the hydrogen storage material comprises a dopant for example a catalyst and/or an additive and/or wherein the hydrogen storage material is provided in a solvent. The catalyst may be as described previously. For some LOHCs, a solvent, for example an organic solvent such as toluene or tetrahydrofuran, may be preferred.

### Foam

In one example, the hydrogen storage device comprises a thermally-conducting foam, for example a metal foam, attached and/or attachable to (i.e. thermally coupled to, in thermal contact with, thermally coupleable to) the thermally conducting network. The inventors have found that such a foam aids heat transfer to and from the hydrogen storage material. It is known that such a foam has a high internal surface area. In one example, the foam comprises and/or is an open-celled foam, preferably an open-celled metal foam (also known as a metal sponge. Open-cell metal foams are generally manufactured by foundry or powder metallurgy. In the powder method, “space holders” are used; they occupy the pore spaces and channels. In casting processes, foam is typically cast with an open-celled polyurethane foam skeleton. Open foams may also be manufactured by bubbling gas through molten liquid, for example. The inventors have found that the hydrogen storage material may be placed in the spaces (i.e. voids, lumens, pores, cells) in the foam and the hydrogen storage material retains its ability to store and release hydrogen whilst at the same time benefiting from the enhanced rate of thermal transfer brought about by the high surface area of the foam. It should be understood that a foam pore size (i.e. cell size) is larger than a size of the hydrogen storage material, for example particles thereof. In one example, a ratio of the foam pore size to a particle size is at least 5:1, for example at least 10:1, for example 20:1, wherein sizes (i.e. foam pore size and particle size) are measurements in one dimension, for example diameter. In one example, the foam comprises and/or is a metal foam, preferably an open-celled metal foam, formed from aluminium, copper, stainless steel, nickel or zinc (or combination alloys including those metals). Aluminium foam is especially preferred. The thermally conducting network preferably contains metal foam in the spaces in the network. The voids in the metal foam contain the hydrogen storage material. It has been found that the metal foam in the thermally conducting network provides excellent transfer of heat from first heater to the hydrogen storage material.

### Unfilled Volume

In one example, the hydrogen storage device is arranged to be oriented horizontally or vertically, in use. In one example, the thermally conducting network partially fills an internal volume of the first vessel, of at least 50%, preferably of at least 60%, more preferably of at least 70% by volume of the first vessel, thereby defining an unfilled volume, being the remainder of the internal volume of the first vessel not filled by the thermally conducting network. It should be understood that the volume of the thermally conducting network is the gross volume thereof, defined by an envelope thereof, and thus includes the volume of the voids therein in addition to the volume of the arms and nodes thereof. In one example, the unfilled volume acts as a buffer, providing a reservoir of hydrogen during charging and similarly during release, for example to account for kinetics thereof. In one example, the first vessel comprises a mesh or a perforated sheet, arranged to cover an open area of the thermally conducting network (i.e. not thermally coupled to the first vessel, for example), to thereby retain the hydrogen storage material in the voids defined within the thermally conducting network.

### Heater

The hydrogen storage device comprises the first heater. In one example, the hydrogen storage device comprises a set of heaters including the first heater and the thermally conducting network is thermally coupled to the first heater. By heating the first heater, heat is transferred to the thermally conducting network thermally coupled thereto. In turn, heat is transferred to the hydrogen storage material in thermal contact, at least in part, with the thermally conducting network. In this way, the hydrogen storage material is heated by the first heater, via the thermally conducting network, thereby causing hydrogen to be released from the hydrogen storage material, during unloading for example. In one example, the first heater is positioned inside the first vessel. In one example, the first heater is positioned outside of the first vessel. Positioning the first heater outside the first vessel simplifies certain aspects of the assembly of the device and allows simpler access for electrical wiring. In one example, the first heater comprises a Joule heater, a recirculating heater and/or a hydrogen catalytic combustor, preferably wherein the hydrogen storage device, for example the first vessel, is arranged to interchangeably receive the Joule heater and the recirculating heater therein and/or thereon. In one example, the first heater comprises and/or is a thermoelectric heater and/or a Joule heater. Other heaters are known. In one example, the hydrogen storage device comprises a thermocouple connected to the first heater, for example via a proportional-integral-derivative (PID) control. In this way, a temperature of the first heater may be controlled. In one example, the first heater comprises and/or is a cartridge heater or an insertion heater. Generally, cartridge heaters are elongated cylinders including electrical resistive wire, for example embedded in magnesium oxide. Suitable cartridge heaters and insertion heaters are available from Watlow (MO, USA). In one example, the first heater is inserted into a passageway formed in and/or provided by the thermally conducting network. In one example, the first heater is integrated into the thermally conducting network, for example integrally formed therewith. In this way, a heating efficiency of the thermally conducting network is improved. In one example, the hydrogen storage device comprises a battery, preferably a rechargeable battery for example a Li-ion polymer battery, arranged to provide electrical power to the first heater. In one example, the first heater comprises and/or is a hydrogen catalytic combustor. In this way, some of the hydrogen released from the hydrogen storage material may be combusted so as to heat the thermally conducting network to release more hydrogen from the LOHC. Alternatively, hydrogen may be combusted so as to heat the thermally conducting network to store hydrogen in the LOC.

In one example, the first heater comprises a Joule heater and/or a recirculating heater, preferably wherein the hydrogen storage device, for example the first vessel, is arranged to interchangeably receive the Joule heater and the recirculating heater therein and/or thereon, as described above.

In one example, the first heater is arranged to provide a heat output in a range from 0.1 MW m⁻³ to 50 MW m⁻³, preferably in a range from 1 MW m⁻³ to 25 MW m⁻³, more preferably in a range from 2.5 MW m⁻³ to 10 MW m⁻³. It should be understood that the heat output is by volume of the first vessel. In this way, hydrogenation and/or dehydrogenation of the hydrogen storage material may be accelerated.

In one example, the first heater is arranged to heat the hydrogen storage material to temperature in a range from 50° C. to 400° C., in a range from 500° C. to 400° C., preferably in a range from 125° C. to 350° C., more preferably in a range from 150° C. to 300° C. In this way, the hydrogen storage material may be heated to a sufficiently high temperature for hydrogenation and/or dehydrogenation.

In one example, the hydrogen storage device comprises a set of heater/coolers, including the set of heaters, including a first heater, comprising the first heater. Particularly, hydrogenation is exothermic and thus the hydrogen storage material may be heated, so as to improve kinetics of hydrogenation and then subsequently cooled, to control the temperature during hydrogenation. In contrast, dehydrogenation is endothermic and thus the hydrogen storage material may be heated, so as to improve kinetics of dehydrogenation and then subsequently heated for example continuously, to control the temperature during dehydrogenation. By cooling the first heater/cooler, heat is transferred from the thermally conducting network thermally coupled thereto. In turn, heat is transferred from the hydrogen storage material in thermal contact, at least in part, with the thermally conducting network. In this way, the hydrogen storage material is cooled by the first heater/cooler, via the thermally conducting network, thereby allowing hydrogen to be stored in the hydrogen storage material. In other words, the first heater/cooler can, in a space-efficient manner, enable heat to be removed from the hydrogen storage material during the hydrogen storage phase, and heat to be supplied to the hydrogen storage material during hydrogen release. In one example, the first heater/cooler is positioned inside the vessel. In one example, the first heater/cooler is positioned outside of the vessel. Positioning the first heater/cooler outside the vessel simplifies certain aspects of the assembly of the device and allows simpler access for electrical wiring. Thermoelectric heater and/or cooler devices can be very closely controlled (i.e. accurately, precisely and/or responsively), which providing control to a high degree of accuracy, precision and/or short response times. The heater of the first heater/cooler may be as described above with respect to the first heater. In one example, the cooler of the first heater/cooler comprises and/or is a heat sink, optionally with active cooling by air propelled by a fan or by a cooling fluid (e.g. water) being propelled by a pump. In one example, the first heater/cooler comprises and/or is a Peltier device or other device that makes use of thermoelectric cooling and heating. Devices of this type are commonly referred to as a Peltier heat pump, a solid state refrigerator, or a thermoelectric cooler (TEC). A thermoelectric heater and cooler device may be used together with a heat sink with optional active cooling (e.g. active cooling by air propelled by a fan or active cooling by a cooling fluid (e.g. water) being propelled by a pump). Application of heat or removal of heat on the side of the thermoelectric device that is not thermally coupled to the thermally conducting network enhances the ability of the thermoelectric device to heat and cool the thermally conducting network. In one example, the first heater/cooler (e.g. a thermoelectric heater and cooler) is in thermal contact with the thermally conducting network. As the two are in thermal contact, heat can efficiently be passed from one to the other. The heat can pass in either direction—heating the thermally conducting network or cooling it. The contact between the heater/cooler module and the thermally conducting network need not be direct physical contact. In some embodiments, there are intervening materials, such as a wall of the vessel. In such an embodiment, the intervening material must continue to allow for good thermal contact between the heater/cooler module and the thermally conducting network, such that heat can pass efficiently from one to the other. Suitable thermoelectric heater and/or cooler devices are known to the person skilled in the art and they are available commercially from most electronics suppliers, such as CUI Inc (OR, USA). In one example, the hydrogen storage device comprises one or more of thermoelectric heaters and/or coolers on a base to provide a Peltier heater/cooler assembly, wherein the thermally conducting network is thermally coupled (for example, attached) to the Peltier heater/cooler assembly. For example, the thermally conducting network may be 3D printed onto the heater/cooler assembly. Optionally, foam (for example metal foam, as described below) may be attached to the thermally conducting network, for example by application of an appropriate amount of compression. Alternatively, the foam may be attached by a physical bond for example by soldering, brazing and/or welding the thermally conducting network and foam together. In such an arrangement, it is preferred for the solder and/or filler to have high thermal conductivity, which is the case for most solder and filler materials.

### Hydrogen Storage Density

In one example, the hydrogen storage device has a hydrogen storage density of at least 0.01 wt. %, at least 1 wt. %, preferably at least 2 wt. %, more preferably at least 3 wt. %, most preferably at least 5 wt. %, by wt. % of the hydrogen storage material. In one example, the hydrogen storage device has a hydrogen storage density of at most 50 wt. %, at most 40 wt. %, at most 30 wt. %, at most 25 wt. %, preferably at most 20 wt. %, more preferably at most 15 wt. %, most preferably at most 12.5 wt. %, by wt. % of the first hydrogen storage first vessel. In this way, the hydrogen storage density may exceed energy storage in a Li-ion polymer battery (about 1.8 wt. % hydrogen storage density equivalent) and may exceed hydrogen storage density in a conventional compressed hydrogen cylinder at 300 bar.

### Hydrogen Storage Capacity

In one example, the hydrogen storage device has a hydrogen storage capacity in a range from 0.1 g to 200 kg, in a range from 0.5 g to 10 kg, 20 kg, 50 kg or 100 kg, a range from 1 g to 2,500 g, preferably in a range from 5 g to 1,000 g, more preferably in a range from 20 g to 500 g. Typically, 1 kg hydrogen may provide about 16.65 kWh of electrical energy, assuming a 50% efficiency in converting from chemical energy of the hydrogen to electrical energy, for example via a fuel cell. In this way, the hydrogen storage device may provide an amount of electrical energy, via a fuel cell for example, in a range from 0.01665 kWh to 41.625 kWh, preferably in a range from 0.08325 kWh to 16.65 kWh, more preferably in a range from 0.333 kWh to 8.325 kWh per kg of hydrogen.

### Hydrogen Storage Material

The first vessel is arranged to receive therein the hydrogen storage material in thermal contact, at least in part, with the thermally conducting network, wherein the hydrogen storage material comprises the liquid organic hydrogen carrier, LOHC.

As an alternative to storage of hydrogen as a compressed gas or as a liquid, certain unsaturated organic compounds permit reversible storage and release of hydrogen (i.e. hydrogen storage materials). These hydrogen storage materials, due to their high hydrogen-storage efficiency, including low hydrogen loss during cycling and/or reduced heat loss between cycles (thermal efficiency), are considered superior to conventional methods of hydrogen storage. Particularly, by storing hydrogen as a LHOC, a greater volumetric storage density may be achieved than possible for hydrogen as a compressed gas or as a liquid. In addition, hydrogen storage as a LOHC presents a reduced safety risk compared with storing hydrogen as a compressed gas or as a liquid.

For example, unsaturated organic compounds can store large amounts of hydrogen by absorbing hydrogen with a high density and by forming saturated organic compounds under a certain temperature/pressure conditions, and hydrogen can be released by changing these conditions.

Generally, an efficiency of exchange of hydrogen into and out of such storage materials may be enhanced or inhibited by their respective heat transfer capabilities. Particularly, hydrogenation (loading of LOC to LOHC, thereby storing hydrogen) is exothermic and dehydrogenation (unloading of LOHC to LOC, thereby releasing hydrogen) is endothermic. Therefore, moving heat within such storage materials or maintaining preferred temperature profiles across and through volumes of such storage materials becomes a crucial factor in such hydrogen storage materials.

Heat ineffectively supplied or removed causes hydrogenation and dehydrogenation to slow down or terminate. This becomes a serious problem which prevents fast charging and release. During fast charging and release, considerable amounts of heat are required to heat and cool the LOC and LOHC, respectively, and particularly, should be supplied homogeneously given the relatively low thermal conductivity of LOC and LOHC. The hydrogen storage device described herein, particularly the thermally conducting network, provides for effective heating and cooling of the hydrogen storage material to facilitate fast charging and release.

The hydrogen storage devices described herein allow for rapid charging and discharging of hydrogen gas while may also be relatively compact. The hydrogen storage devices allow for rapid heating and cooling, particularly via the thermally conducting network, which means less heat is wasted to the surroundings during operation, since the charging and discharging times are relatively short. The hydrogen storage devices also enable highly targeted heating, which avoids unnecessary heat loss and associated wasted energy.

In one example, the LOHC comprises and/or is a saturated cycloalkene, aromatic, heterocyclic aromatic and/or a mixture thereof. It should be understood that LOHC generally refers to the hydrogenated (i.e. loaded, saturated) liquid organic compound while LOC generally refers to the dehydrogenated (i.e. unloaded, unsaturated) liquid organic compound. However, in practice, a given molecular name may be used interchangeably to refer to both, with the correct meaning understood by the skilled person in the given context. Hence, for example, N-ethylcarbazole (NEC) may be referred to commonly as a LOHC yet is unsaturated. Research on LOHC was initially focussed on cycloalkanes, having a relatively high hydrogen capacity (6-8 wt. % and production of COx-free hydrogen. Heterocyclic aromatic compounds (or N-Heterocycles) are also appropriate. N-Ethylcarbazole (NEC) is a well-known LOHC but many other LOHCs are known. With a wide liquid range between −39° C. (melting point) and 390° C. (boiling point) and a hydrogen storage density of 6.2 wt. %, dibenzyltoluene is ideally suited as LOHC material. Formic acid has been suggested as a promising hydrogen storage material with a 4.4 wt. % hydrogen capacity. Using LOHCs relatively high gravimetric storage densities can be reached (about 6 wt. %) and the overall energy efficiency is higher than for other chemical storage options such as producing methane from the hydrogen.

In one example, the LOHC and/or the hydrogen storage material comprises and/or is N-ethylcarbazole (NEC), monobenzyltoluene (MBT), dibenzyltoluene (DBT), 1,2-dihydro-1,2-azaborine (AB), toluene (TOL), naphthalene (NAP), benzene, phenanthrene, pyrene, pyridine, chinoline, flurene, carbazole, methanol, formic acid, phenazine, ammonia and/or mixtures thereof. NEC and/or DBT may be preferred. Cycloalkanes reported as LOHCs include cyclohexane, methyl-cyclohexane and decalin. The dehydrogenation of cycloalkanes is highly endothermic (63-69 kJ/mol H2), which means this process requires relatively high temperatures and/or heat inputs. Dehydrogenation of decalin is the most thermodynamically favoured among the three cycloalkanes, and methyl-cyclohexane is second because of the presence of the methyl group. Ni, Mo and Pt based catalysts have been investigated for dehydrogenation. However, coking is still a big challenge for catalyst's long-term stability. Generally, hydrogenation and dehydrogenation of LOHCs requires catalysts. It was demonstrated that replacing hydrocarbons by hetero-atoms, like N, O etc. improves reversible de/hydrogenation properties. The temperature required for hydrogenation and dehydrogenation drops significantly with increasing numbers of heteroatoms. Among all the N-heterocycles, the saturated-unsaturated pair of dodecahydro-N-ethylcarbazole (12H-NEC) and NEC has been considered as a promising candidate for hydrogen storage with a fairly large hydrogen content (5.8 wt %). The standard catalyst for NEC to 12H-NEC is Ru and Rh based. The selectivity of hydrogenation can reach 97% at 7 MPa and 130° C. to 150° C. Although N-heterocyles can optimize the unfavourable thermodynamic properties of cycloalkanes, challenges include relatively high cost, high toxicity and/or kinetic barriers. Use of formic acid as a hydrogen storage material has been reported. Carbon monoxide free hydrogen has been generated in a very wide pressure range (1-600 bar). A homogeneous catalytic system based on water-soluble ruthenium catalysts selectively decompose HCOOH into H₂ and CO₂ in aqueous solution. This catalytic system overcomes the limitations of other catalysts (e.g. poor stability, limited catalytic lifetimes, formation of CO) for the decomposition of formic acid making it a viable hydrogen storage material. The co-product of this decomposition, carbon dioxide, can be used as hydrogen vector by hydrogenating it back to formic acid in a second step. The catalytic hydrogenation of CO₂ has long been studied and efficient procedures have been developed. Formic acid contains 53 g L⁻¹ hydrogen at room temperature and atmospheric pressure. By weight, pure formic acid stores 4.3 wt. % hydrogen. Pure formic acid is a liquid with a flash point 69° C. However, 85% formic acid is not flammable. Ammonia (NH₃) releases H₂ in an appropriate catalytic reformer. Ammonia provides high hydrogen storage densities as a liquid with mild pressurization and cryogenic constraints: It can also be stored as a liquid at room temperature and pressure when mixed with water. Ammonia is the second most commonly produced chemical in the world and a large infrastructure for making, transporting, and distributing ammonia exists. Ammonia can be reformed to produce hydrogen with no harmful waste.

In use, during storage of hydrogen, hydrogen may be received into the first vessel of the hydrogen storage device via the first fluid inlet, for example from a hydrogen gas generator, as described below. Preferably, the hydrogen storage device is initially in a fully discharged state. When the hydrogen comes into contact with the hydrogen storage material, a temperature of the hydrogen storage material increases due to the exothermic absorption (i.e. hydrogenation) reaction of the hydrogen storage, as described previously. Heat from the exothermic reaction is conducted via the thermally conducting network, thereby attenuating the increase in the temperature. Optionally, a first cooler may be activated to further attenuate the increase in the temperature and subsequently, deactivated when a set low temperature threshold is reached (for example 20° C.). A valve inline with the first fluid inlet may be opened, to admit the hydrogen, and closed, to contain the hydrogen, for example when a pressure within the first vessel reaches, for example stabilises, at predetermined operating pressure (for example 10 bar). Depending on a type of hydrogen storage material, kinetics of absorption may be different and thus this step of storage of the hydrogen may be modified accordingly. For example, to accelerate storage of hydrogen, absorption thereof may be preferred at higher temperatures, for example of at least 100° C., to favour kinetics of hydrogenation.

In use, during release of hydrogen (i.e. dehydrogenation), a reverse process to storage occurs. A valve inline with the first fluid outlet may be opened, to allow exit of the hydrogen therethrough, for example to an electrical generator. As hydrogen is released from the hydrogen storage material, the temperature thereof decreases due to the endothermic desorption, as described previously. The first heater heats the thermally conducting network and hence the hydrogen storage material, for example as activated by a temperature measurement of the thermally conducting network using a thermocouple. The first heater may be deactivated once a set high temperature threshold is reached (for example 80° C.). The valve may be then closed when the pressure reaches, for example stabilises at, a predetermined pressure is reached (for example 1 bar).

### Arrangements

In one example, the hydrogen storage device is arrangeable, for example repeatedly, in: a first arrangement wherein the thermally conducting network is within the first vessel; and a second arrangement wherein the thermally conducting network is outside the first vessel; optionally wherein the first vessel comprises a circumferential releasable joint. It should be understood that the first arrangement is the in use arrangement and the second arrangement is, for example, an assembly arrangement. In one example, the first inlet and/or the first outlet is arranged, for example sized, to permit insertion and/or removal of the thermally conducting network therethrough. In one example, the first vessel comprises a releasable port for insertion and/or removal of the thermally conducting network therethrough. In one example, the first vessel comprises a circumferential releasable joint, such that the first vessel may be parted to allow insertion and/or removal of the thermally conducting network. It should be understood that a circumferential joint includes a peripheral joint (i.e. around a periphery of the first vessel) and hence applies also to non-cylindrical first vessels. In one example, the first vessel comprises a longitudinal releasable joint, such that the first vessel may be parted to allow insertion and/or removal of the thermally conducting network. More generally, in one example, the first vessel comprises a releasable joint, such that the first vessel may be parted to allow insertion and/or removal of the thermally conducting network. In one example, the releasable joint comprises a mechanical fastener, for example a threaded joint, a bolted joint, a clamped joint. In one example, the releasable joint comprises a gasket. It should be understood that the releasable port and/or the releasable joint comply with standards for first vessels, as described above. In one example, the first vessel comprises a sealable joint, such that the first vessel may be manufactured in two or more parts to allow insertion of the thermally conducting network and the sealable joint subsequently sealed, for example permanently. In one example, the thermally conducting network comprises an expandable thermally conducting network. In this way, the thermally conducting network may be inserted through the first inlet and/or the first outlet into the first vessel and subsequently expanded, for use. For example, nodes of the thermally conducting network may be moveable nodes and/or arms of the thermally conducting network may be extensible arms. In one example, the thermally conducting network comprises a contractable thermally conducting network. In this way, the thermally conducting network may be removed through the first inlet and/or the first outlet into the first vessel by contracting the thermally conducting network and removing the contracted thermally conducting network, for use. For example, nodes of the thermally conducting network may be moveable nodes and/or arms of the thermally conducting network may be contractable arms. In this way, size of the first inlet and/or the first outlet may be relatively small, compared with an expanded size of the thermally conducting network. In one example, the thermally conducting network comprises a foldable, such as a foldable tessellated, structure of nodes and arms.

### Heat Exchanger

In one example, the hydrogen storage device comprises a heat exchanger configured to exchange heat from and/or to the LOHC, for example between the LOC and the LOHC and/or vice versa. For example, dehydrogenation (unloading of LOHC to LOC, thereby releasing hydrogen) is endothermic and generally requires a heat input to the LOHC. In this way, by exchanging heat, for example residual heat, from the dehydrogenated LOC to the LOHC to be dehydrogenated, the heat input is decreased, thereby reducing the heat input, enabling minimization of heat wastage and/or maximization of efficiency of the hydrogen storage device. In one example, the heat exchanger comprises and/or is cocurrent or a countercurrent heat exchanger, preferably a countercurrent heat exchanger. In one example, the heat exchanger is in thermal contact, at least in part, with the thermally conducting network. In one example, the thermally conducting network comprises the heat exchanger, for example integrated (such as integrally formed by 3D printing) therewith.

### Thermal Insulation

In one example, the hydrogen storage device comprises thermal insulation, configured to thermally insulate the first vessel. In this way, heat losses are reduced, for example during dehydrogenation of hydrogen storage material, for example the LOHC, thereby reducing a heat input during dehydrogenation, enabling minimization of heat wastage and/or maximization of efficiency of the hydrogen storage device. In one example, the first vessel comprises a double wall (i.e. an inner pressure wall, for example an inner skin, and an outer wall, for example an outer skin), thereby providing, at least in part, the thermal insulation. In this way, a gap between the double wall may provide a thermally insulating layer and/or comprise a thermally insulating layer. In one example, the double wall is integrated (such as integrally formed by 3D printing) with the first vessel.

### Expansion Tanks

In one example, the first vessel comprises a set of expansion tanks (also known as bladders), including a first expansion tank and a second expansion tank, wherein the first expansion tank and the second expansion tank are mutually fluidically coupled. In this way, LOHC received in the first expansion tank may flow, for example using a pump, to the second expansion tank and dehydrogenated during the flowing, whereby LOC is received in the second expansion tank. In this way, the LOHC and the LOC are received in separate expansion tanks. Since the first and second tanks are expansion tanks, as the LOHC flows from the first expansion tank, a volume thereof correspondingly decreases while a volume of the second expansion tank correspondingly increases as the LOC is received therein, thereby maintaining a substantially constant total volume, corresponding with a total volume of the LOHC and LOC, while separating the LOHC and LOC. In contrast, two separate non-expanding tanks would each require a capacity corresponding with a total volume of the LOHC and LOC. Hence, in this way, the set of expansion tanks reduces and/or minimises a volume and/or mass of the hydrogen storage device.

### Method

The second aspect provides a method of storing hydrogen comprising passing hydrogen gas into a hydrogen storage device according to the first aspect, comprising heating and cooling the thermally conducting network.

The third aspect provides a method of providing hydrogen comprising releasing hydrogen gas from a hydrogen storage device according to the first aspect, comprising heating the thermally conducting network.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1A is a CAD partial cutaway perspective view of a hydrogen storage device according to an exemplary embodiment; FIG. 1B is a CAD longitudinal perspective cross-sectional view of the hydrogen storage device; and FIG. 1C is a CAD perspective view of the thermally conducting network, in more detail;

FIG. 2 schematically depicts hydrogenation and dehydrogenation of a LOHC;

FIG. 3 is a graph showing rates of heat transfer for a hydrogen storage device according to an exemplary embodiment and a comparative example;

FIGS. 4A to 4E schematically depict hydrogenation and dehydrogenation for N-ethylcarbazole (NEC), dibenzyltoluene (DBT), 1,2-dihydro-1,2-azaborine (AB), toluene (TOL) and naphthalene (NAP), respectively;

FIG. 5 schematically depicts an apparatus and a method according to an exemplary embodiment;

FIG. 6 schematically depicts the apparatus and the method of FIG. 5, in more detail;

FIGS. 7A to 7G are CAD perspective views of thermally conducting networks, particularly Bravais lattices, for a hydrogen storage device according to an exemplary embodiment;

FIG. 8A is a graph of effective thermal conductivity as a function of porosity for the thermally conducting networks of FIGS. 7A to 7G; and FIG. 8B is a graph of effective thermal conductivity as a function of surface area for the thermally conducting networks of FIGS. 7A to 7G;

FIG. 9 is a graph of concentration of dehydrogenation products of NEC as a function of time;

FIGS. 10A to 10D are graphs of concentration of dehydrogenation products of NEC as a function of time;

FIGS. 11A to 11B schematically depict computational fluid dynamic (CFD) modelling of dehydrogenation of a hydrogen storage material in a hydrogen storage device according to an exemplary embodiment;

FIG. 12A is a graph of dehydrogenation of NEC-H12 as a function of first vessel volume for different heat inputs; and FIG. 12B is a graph of conversion as a function of time for different porosities of the thermally conducting network.

FIG. 13A is a cutaway perspective view of a hydrogen storage device according to an exemplary embodiment; and FIG. 13B is a cutaway perspective exploded view of a related hydrogen storage device;

FIG. 14 is a cutaway perspective view of a hydrogen storage device according to an exemplary embodiment;

FIGS. 15A to 15C schematically depict hydrogen storage devices according to exemplary embodiments;

FIG. 16 is a photograph of a foam for a hydrogen storage device according to an exemplary embodiment;

FIG. 17 is a CAD cutaway perspective view of a thermally conducting network for a hydrogen storage device according to an exemplary embodiment;

FIG. 18A is a CAD cutaway perspective view of a hydrogen storage device according to an exemplary embodiment; FIG. 18B is a CAD axial cross-section perspective view of the hydrogen storage device; and FIG. 18C is a CAD perspective view of the thermally conducting network of the hydrogen storage device; and

FIG. 19A is a CAD perspective view of a hydrogen storage device according to an exemplary embodiment; FIG. 19B is a CAD perspective semi-transparent view of the hydrogen storage device of FIG. 19A; and FIG. 19C is a CAD axial cross-section view of the hydrogen storage device of FIG. 19A.

### DETAILED DESCRIPTION OF THE DRAWINGS

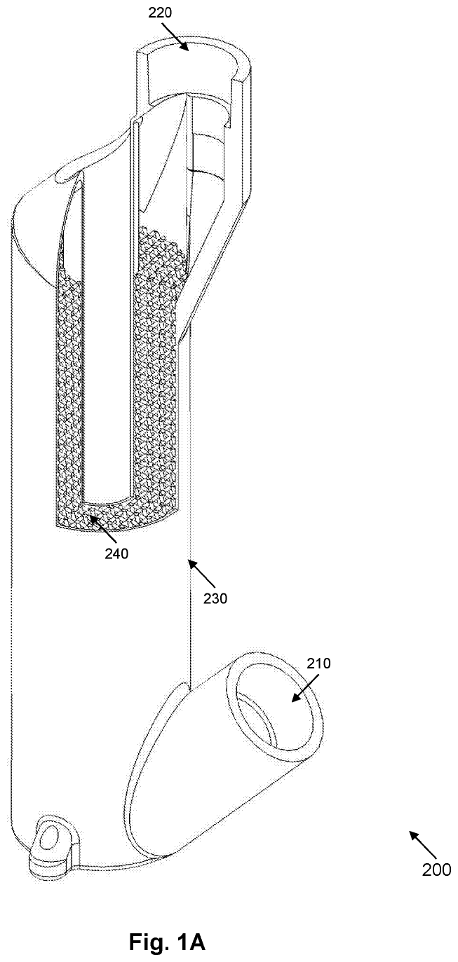

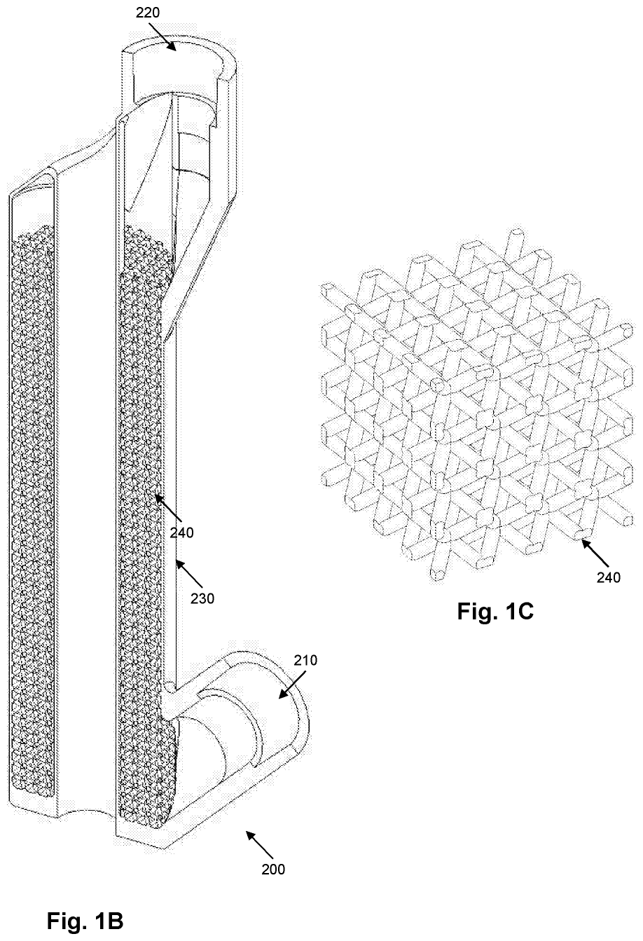

FIG. 1A is a CAD partial cutaway perspective view of a hydrogen storage device 200 according to an exemplary embodiment; FIG. 1B is a CAD longitudinal perspective cross-sectional view of the hydrogen storage device 200; and FIG. 1C is a CAD perspective view of the thermally conducting network 240, in more detail.

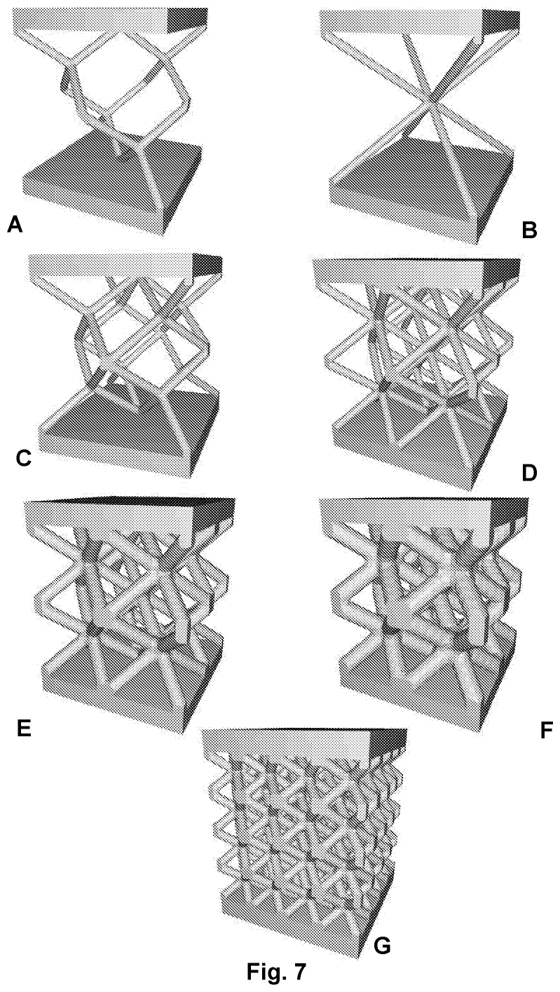

The hydrogen storage device 200 comprises: a first vessel 230, having a first fluid inlet 210 and a first fluid outlet 220, having therein a thermally conducting network 240 thermally coupled to a first heater (not shown); wherein the first vessel 230 is arranged to receive therein a hydrogen storage material in thermal contact, at least in part, with the thermally conducting network 240; wherein the thermally conducting network 240 has a lattice geometry in three dimensions, comprising a plurality of nodes, having thermally conducting arms therebetween, with voids between the arms; and wherein the hydrogen storage material comprises and/or is a liquid organic hydrogen carrier, LOHC. In this example, the hydrogen storage device 200 is a dynamic hydrogen storage device 200. In this example, the first fluid inlet 210 and the first fluid outlet 220 are mutually spaced apart at opposed ends of the first vessel 230, thereby defining, at least in part, a path for flow of the hydrogen storage material and/or hydrogen therebetween, for example via the voids of the thermally conducting network 240. In this example, the first fluid inlet 210 and the first fluid outlet 220 comprise releasable couplings, thereby providing coupling thereto and uncoupling therefrom, for example repeatedly, of corresponding couplings. In this example, the lattice geometry is Bravais lattice particularly a cubic lattice specifically a primitive cubic lattice, as shown also in FIG. 7G. In this example, the thermally conducting arms have a cross sectional dimension (for example a diameter or a width) of about 0.5 mm. In this example, the thermally conducting network 240 partially fills an internal volume of the first vessel 230, of at least 90%, by volume of the first vessel 230. In this example, the thermally conducting network 240 comprises a LOHC hydrogenation and/or dehydrogenation catalyst, for example provided on and/or in a surface thereof. In this example, the thermally conducting network 240 has a porosity in a range from 75% to 95%, by volume of the thermally conducting network 240. In this example, the thermally conducting network 240 has a specific surface area in a range from 1 m⁻¹ to 10 m⁻¹, particularly about 7 m⁻¹. In this example, the thermally conducting network 240 comprises a LOHC hydrogenation and/or dehydrogenation catalyst, for example provided on and/or in a surface thereof. In this example, the first heater is arranged heat the hydrogen storage material to temperature in a range from 150° C. to 300° C. In this example, the hydrogen storage device 200 comprises a pump (not shown) arranged to flow the hydrogen storage material through the first vessel 230. In this example, the hydrogen storage device 200 is a reactor.

Generally, the first vessel 230 is an elongated cylinder formed from a Ti alloy (to withstand an operating pressure of about 2 bar at a temperature of about 260° C. for dehydrogenation), having a bore extending therethrough for the first heater, particularly a Joule cartridge heater. The first fluid inlet 210 and the first fluid outlet 220 are provided with Swagelok releasable couplings. The first fluid inlet 210 is arranged at an acute angle to the axis of the first vessel and the first fluid outlet is arranged parallel to the axis, to suit the particular application.

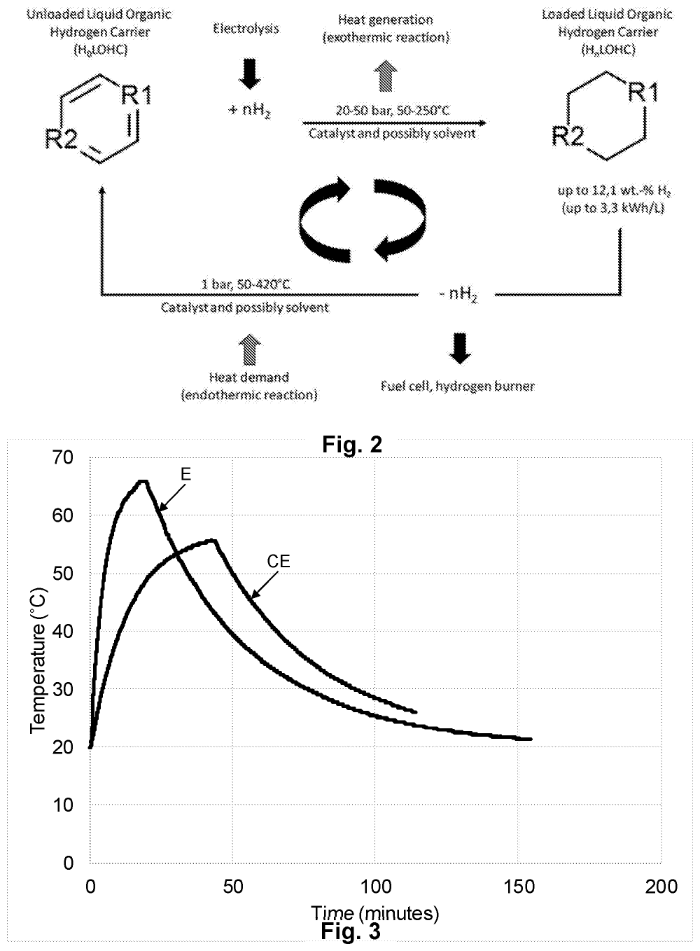

FIG. 2 schematically depicts hydrogenation and dehydrogenation of a LOHC. Hydrogentation, from H₀LOHC (also known as LOC) to HₙLOHC (also known as LOHC), is typically catalysed, optionally in the presence of a solvent, at a relatively higher pressure of typically 20 to 50 bar and a temperature of typically 5° C. to 250° C. and is exothermic. HₙLOHC effectively stores up to 12.1 wt. % H₂, representing an energy storage density of 3.3 kWh L⁻¹. Dehydrogentation, from HₙLOHC to H₀LOHC, is typically catalysed by, optionally in the presence of a solvent, at a relatively lower pressure of typically 1 bar and a temperature of typically 50° C. to 420° C. and is endothermic. Hydrogenation and dehydrogenation are reversible, for example repeatedly. Hence, LOHCs provide relatively high H₂ gravimetric values (compared with conventional storage), require benign operating conditions (high pressures not needed for dehydrogenation), provide efficiency gains (no cryogenic cooling or compression efficiency losses), are zero-emission as hydrogen separated from carrier, carriers are reusable with easy off/on site regeneration using electrolysers/compressed gas and hydrogenation systems, employ similar infrastructure as existing fossil fuels and offer fast refuelling times (removal of spent LOCs and fuelling of LOHC can happen simultaneously in minutes).

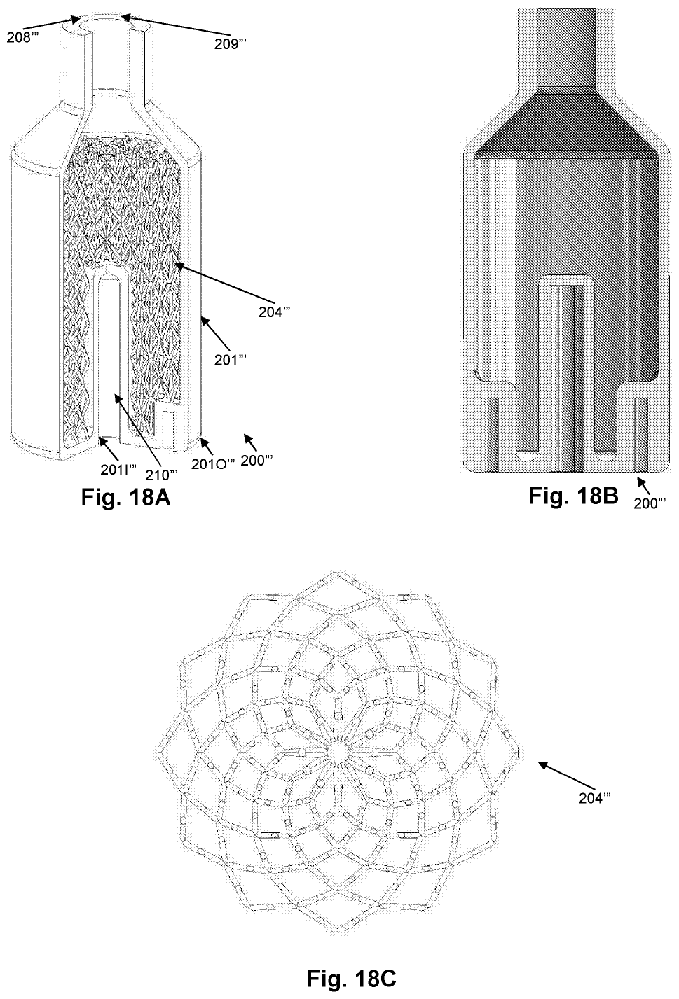

FIG. 3 is a graph showing rates of heat transfer for a hydrogen storage device according to an exemplary embodiment E and a comparative example CE, for heating of water as an example, using the hydrogen storage device of FIGS. 18A to 18C. The comparative example did not include the thermally conducting network of the hydrogen storage device of FIGS. 18A to 18C but otherwise identical. For the same heat input, heating via the thermally conducting network results in a 60% reduction in time until maximum temperature is reached from commencement of heating while the maximum temperature is also about 10° C. higher.

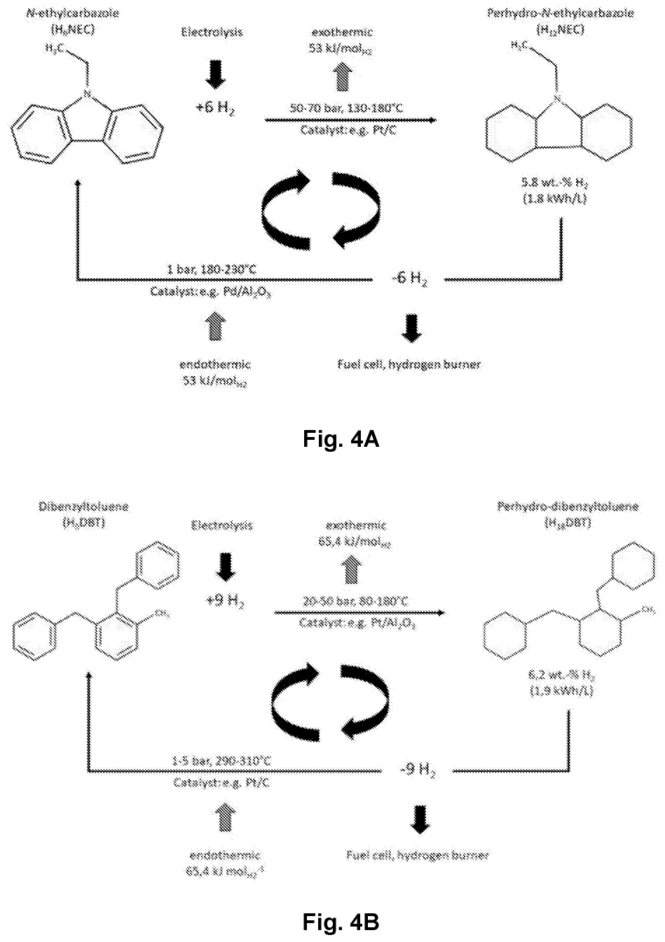

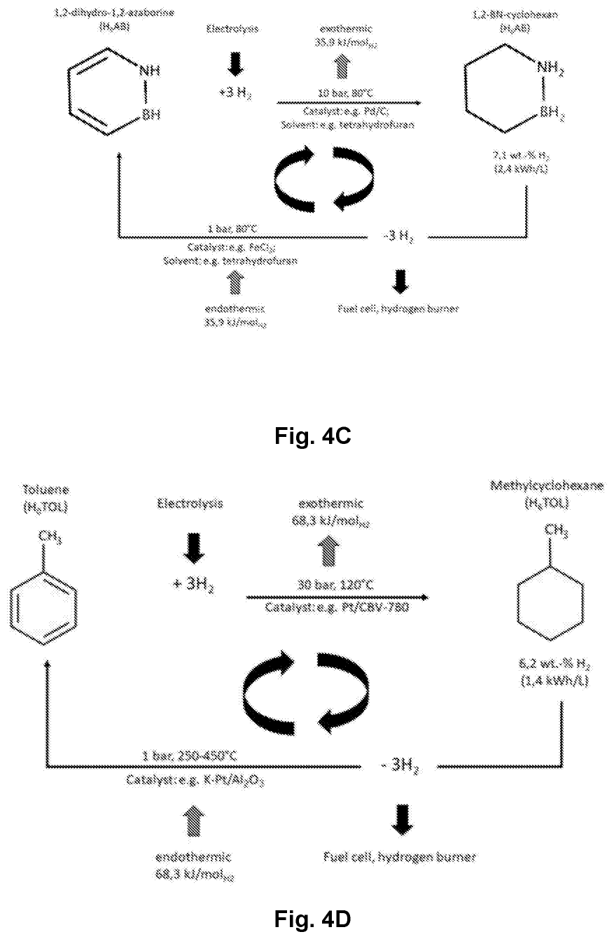

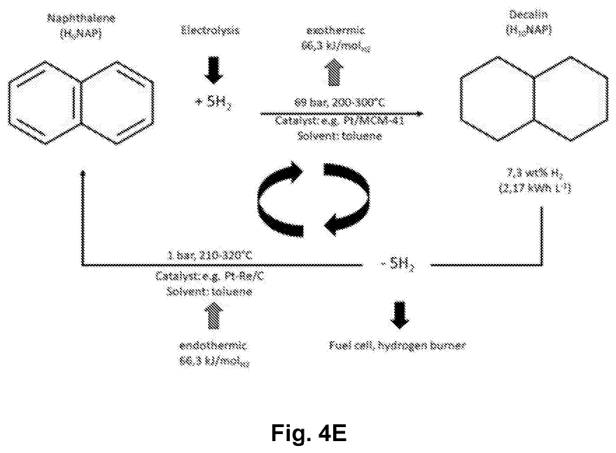

FIGS. 4A to 4E schematically depict hydrogenation and dehydrogenation for N-ethylcarbazole (NEC), dibenzyltoluene (DBT), 1,2-dihydro-1,2-azaborine (AB), toluene (TOL) and naphthalene (NAP), respectively.

FIG. 4A schematically depicts hydrogenation and dehydrogenation for N-ethylcarbazole (NEC). Hydrogentation, from H₀NEC to H₁₂NEC, is catalysed by, for example, Pt/C at a pressure of 50 to 70 bar and a temperature of 130° C. to 180° C. and is exothermic, releasing 53 kJ mol⁻¹ of H₂. Hydrogenation catalysed by Pd and/or Ru on an Al₂O₃ support completes within about 180 minutes at 50 bar and 150° C. H₁₂NEC effectively stores 5.8 wt. % H₂, representing an energy storage density of 1.8 kWh L⁻¹. Dehydrogentation, from H₁₂NEC to H₀NEC, is catalysed by, for example, Pd on an Al₂O₃ support at a pressure of 1 bar and a temperature of 180° C. to 230° C. and is endothermic, requiring 53 kJ mol⁻¹ of H₂ and completes within about 25 minutes at 270° C. or 250 minutes at 180° C.

Table 1 summarises properties and requirements of NEC.

| Criteria | Notes | Comments |
|---|---|---|
| Storage | 5.8 wt. % (not liq.) but limit to 90% | Weight percentage OK and very |
| | so 5.2 wt. %, 2.5 kWh/L and 2.25 | good volume (67 g H₂/L) |
| | kWh/L | |
| Availability | 40 euro/kg (distillation), global | Only 120 euros, price insensitive |
| | production <10,000 t/a | market and limited amount needed |
| Toxicity | 5.1 TPI/mg | Low |
| Temperature | 180-270° C. | Lower range is preferred |
| Energy | 53.2 kJ/mol | Relatively high (22% of total |
| demand | | hydrogen energy) |
| Material | health hazard, low vapor pressure | No liquid evaporation, but need to |
| handling | (0.05-4.4 Pa), high viscosity | spec pump |
| | (5.9-121 mPas) | |
| Process | Solid at ambient, restrict | No extra equipment |
| design | dehydrogenation to avoid solvent, | |
| | 99.99% pure no purification | |
| Stability | 72 h at 270° C. (<2%), 500,000 kg | Relatively stable |
| | mat/kg cat | |
| Gas flow | 180° C. 68 g/Lhour, 270° C. 163.1 | 152 g H₂/hour at 180° C. |
| | g/Lhour | |

FIG. 4B schematically depicts hydrogenation and dehydrogenation for dibenzyltoluene (DBT). Hydrogentation, from H₀DBT to H₁₈DBT, is catalysed by, for example, Pt on an Al₂O₃ support at a pressure of 20 to 50 bar and a temperature of 80° C. to 180° C. and is exothermic, releasing 65.4 kJ mol⁻¹ of H₂. Hydrogenation catalysed by Pt and/or Ru on an Al₂O₃ support completes within about 240 minutes at 50 bar and 150° C. H₁₈DBT effectively stores 6.2 wt. % H₂, representing an energy storage density of 1.9 kWh L⁻¹. Dehydrogentation, from H₁₈DBT to H₀DBT, is catalysed by, for example, Pt on a C support at a pressure of 1 to 5 bar and a temperature of 290° C. to 310° C. and is endothermic, requiring 65.4 kJ mol⁻¹ of H₂ and completes within about 120 minutes at 310° C.

Table 2 summarises properties and requirements of DBT.

| Criteria | Notes | Comment |
|---|---|---|
| Storage | 6.2 wt. %, 1.9 kWh/L, but limited to 6 | Ideal weight and volume (54 gH2/L) |
| | wt. % and 1.8 kWh/L | |
| Availability | 4 euro/kg | Less than 12 euros for material |
| Toxicity | 13.8 TPI/mg | Relatively low |
| Temperature | 310° C. | Prefer about 200° C., but usable |
| Energy | 65.4 kJ/mol | Higher than used to (27% of total |
| demand | | hydrogen energy) |
| Material | Environmental hazard, low vapor | No liquid evaporation, but need to |
| handling | pressure (0.04-0.07 Pa), high | spec pump |
| | viscosity (44.1-258 mPas) | |
| Process | Liquid, no purification | No extra equipment |
| design | | |
| Stability | 72 h at 270° C. (<0.01%), 14,000 h | Highly stable |
| | (hydrogenation), 8,000 h | |
| | (dehydrogenation) | |
| Gas flow | 270° C. 11.3 g/Lhour, 310° C. 27.5 | Est. 76 gH₂/hour, need 100 gH₂/hour |
| | g/Lhour | |

FIG. 4C schematically depicts hydrogenation and dehydrogenation for 1,2-dihydro-1,2-azaborine (AB). AB is a heterocyclic molecule including B and N heteroatoms. Hydrogentation, from H₀AB to H₆AB, is catalysed by, for example, Pd on a C support, in the presence of a solvent such as tetrahydrofuran, at a pressure of 10 bar and a temperature of 80° C. and is exothermic, releasing 35.9 kJ mol⁻¹ of H₂. Hydrogenation catalysed by Pd on a C support, with a two-step addition by hydride (KH) and proton (HCl) completes to about 95% at 10 bar and 90° C. H₆AB effectively stores 7.1 wt. % H₂, representing an energy storage density of 2.4 kWh L⁻¹. Dehydrogenation, from H₆AB to H₀AB, is catalysed by, for example, FeCl₂ or CoCl₂, in the presence of a solvent such as tetrahydrofuran at a pressure of 1 bar and a temperature of 80° C. and is endothermic, requiring 35.9 kJ mol⁻¹ of H₂ and completes within about 20 minutes (FeCl₂) and about 10 minutes (CoCl₂) at 1 bar and 80° C.

Table 3 summarises properties and requirements of AB.

| Criteria | Notes | Comments |
|---|---|---|
| Storage | 7.1 wt. % 2.4 kWh/L, tetrahydrofuran | Addition of solvent has a detrimental |
| | solvent gives 2.3 wt. % and 0.8 | effect (24 gH2/L) |
| | kWh/L, trimerization gives 4.7 wt. % | |
| | and 1.6 kWh/L | |
| Availability | Price of Boron | — |
| Toxicity | Low | Low |
| Temperature | 80° C. | Very good |
| Energy | 35.9 kJ/mol | Low enthalpy, coupling of |
| demand | | exothermic hydrogenation of B and N |
| Material | high vapor pressure (18,300 Pa), | Difficult storage with low vapor |
| handling | low viscosity (0.55-0.57 mPas) | pressure |
| Process | Tetrahydrofuran solvent, low | Hydrogen purification with solvent, |
| design | flashpoint, multi stage | can ignite on hot surface |
| | hydrogenation | |
| Stability | Air and moisture stable, thermally | Highly stable |
| | stable up to 150° C., no side | |
| | reactions | |
| Gas flow | 132.5 gH₂/Lh CoCl₂, 66.2 gH₂/Lh | More than enough |
| | FeCl₂ (with solvent) | |

FIG. 4D schematically depicts hydrogenation and dehydrogenation for toluene (TOL). Hydrogentation, from H₀TOL to H₀TOL, is catalysed by, for example, Pt on a CBV-780 support, at a pressure of 30 bar and a temperature of 120° C. and is exothermic, releasing 68.3 kJ mol⁻¹ of H₂. Hydrogenation catalysed by Pt on a zeolite support occurs at 30 bar and 120° C. while hydrogenation catalysed by NiCoMo on a zeolite support completes in about 2 hours at 20 bar and 200° C. Dehydrogenation, from H₀TOL to H₀TOL, is catalysed by, for example, K—Pt on an Al₂O₃ support at a pressure of 1 bar and a temperature of 250 to 450° C. and is endothermic, requiring 68.3 kJ mol⁻¹ of H₂. Dehydrogenation catalysed by Pt or Ni on an Al₂O₃ support occurs at about 350 to 450° C. Dehydrogenation catalysed by Raney-Ni gives a yield of about 65% after about 30 minutes at 250° C., but with isomerization and disproportionation. Dehydrogenation catalysed by K—Pt on an Al₂O₃ support gives a yield of about 95% at 320° C.

Table 4 summarises properties and requirements of TOL.

| Criteria | Notes | Comments |
|---|---|---|
| Storage | 6.2 wt. % and 1.6 kWh/L, with limit of | Good (45 gH₂/L) |
| | 95% it is 5.9 wt. % and 1.5 kWh/L | |
| Availability | 0.3 euros per kg | Very cheap |
| Toxicity | 19.3 TPI/mg, probably toxic to | |
| | reproduction | |
| Temperature | 250-450° C. (310° C.) | |
| Energy | 68.3 kJ/mol | Higher than we are used to (29% of |
| demand | | total hydrogen energy) |
| Material | Flammable, health hazard, irritating | Lots of dangers and need to deal |
| handling | to eyes and skin, dangerous to | with vapor pressure |
| | environment, high vapor pressure | |
| | (7880-10900 Pa), low viscosity | |
| | (0.6-0.7 mPas) | |
| Process | Hydrogen purification, toluene gas | Hydrogen purification from toluene, |
| design | means use of fixed bed, low ignition | chance of ignition |
| | temp of product | |
| Stability | Side reactions, catalyst | Issues |
| | deactivation, can add rhenium, | |
| | 6,000 h with K—Pt/Al₂O₃. | |
| Gas flow | 61.6 gH₂/Lh | More than enough |

FIG. 4E schematically depicts hydrogenation and dehydrogenation for naphthalene (NAP). Hydrogentation, from H₀NAP to H₁₀NAP, is catalysed by, for example, Pd on a MCM-41 support, in the presence of a solvent such as toluene, at a pressure of 69 bar and a temperature of 200° C. to 300° C. and is exothermic, releasing 66.3 kJ mol⁻¹ of H₂. Hydrogenation catalysed by aluminium mobile composition of matter (Al-MCM), completes in about 150 minutes at 69 bar and 300° C. or about 480 minutes at 69 bar and 200° C. H₆NAP effectively stores 7.3 wt. % H₂, representing an energy storage density of 2.17 kWh L⁻¹. Dehydrogentation, from H₁₀NAP to H₀NAP, is catalysed by, for example, Pt—Re on a C support, in the presence of a solvent such as toluene at a pressure of 1 bar and a temperature of 210° C. to 320° C. and is endothermic, requiring 66.3 kJ mol⁻¹ of H₂ and completes within about 150 minutes (Pt on a C support) and about 120 minutes (Pt—Re) at 1 bar and 280° C.

Table 5 summarises properties and requirements of AB.

| Criteria | Notes | Comments |
|---|---|---|
| Storage | 7.4 wt. % and 2.2 kWh/L, toluene | Adding solvent is detrimental |
| | solvent makes 3.8 wt. % and 1.1 | (33 gH₂/L) |
| | kWh/L | |
| Availability | 0.6 euros per kg | Very cheap |
| Toxicity | Highly toxic 45.8 TPI/mg and | Very toxic |
| | probably carcinogenic. | |
| Temperature | 280° C. | Relatively high |
| Energy | 66.3 kJ/mol | Higher than we are used to (28% of |
| demand | | total hydrogen energy) |
| Material | Flammable, health hazard, irritating | Handling and storage dangers |
| handling | to eyes and skin, dangerous to | |
| | environment, toxic and corrosive, | |
| | low vapor pressure (235-540 Pa), | |
| | low viscosity (2-3 mPas) | |
| Process | Solid at RT, need to add toluene, | Hydrogen purification from toluene, |
| design | low ignition temperature | chance of ignition |
| Stability | Stable to 450° C., high temperature | Manageable within used |
| | causes catalyst deactivation and | temperature range |
| | carbon deposits | |
| Gas flow | 16.1 gH₂/Lh | Unlikely to be enough |

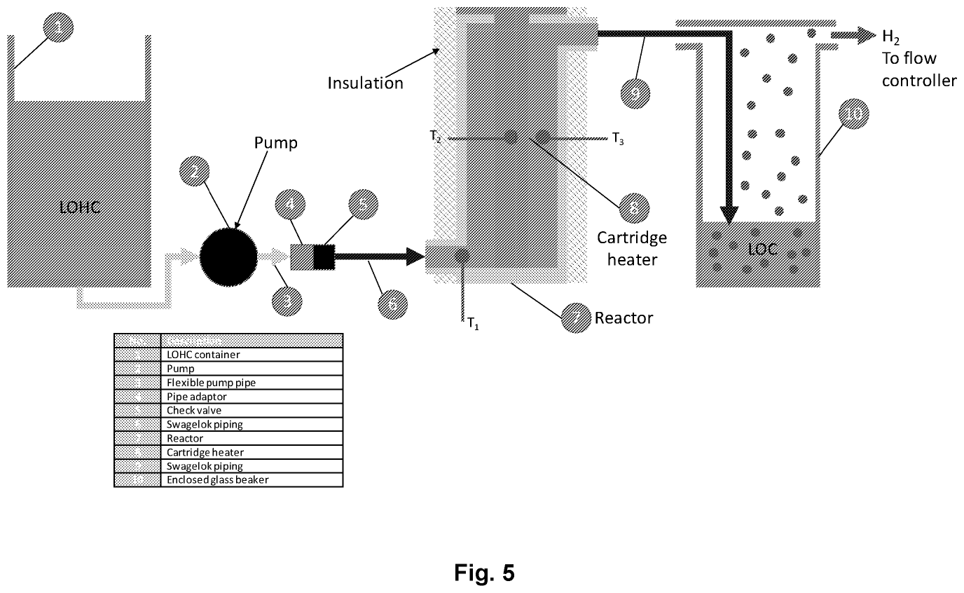

FIG. 5 schematically depicts an apparatus and a method according to an exemplary embodiment. LOHC is pumped, by pump 2, from LOHC container 1 through flexible pipe 3, pipe adapter 4, check valve 4 and Swagelok piping 6 into reactor 7, corresponding with the hydrogen storage device 200 described with reference to FIGS. 1A to 1C. The LOHC received in the reactor 7 is heated by first heater 8, particularly a cartridge heater, via the thermally conducting network as the LOHC flows therethrough, from first fluid inlet to first fluid outlet, thereby releasing hydrogen. The reactor 7 is thermally insulated by insulation, to reduce heat losses and hence improve an efficiency of dehydrogenation. LOC and hydrogen exit the reactor through the first fluid outlet and Swagelok piping 9 into an enclosed gas beaker 10. LOC collects in the beaker while hydrogen gas flow outwards to a flow controller and hence to a hydrogen fuel cell, for example.

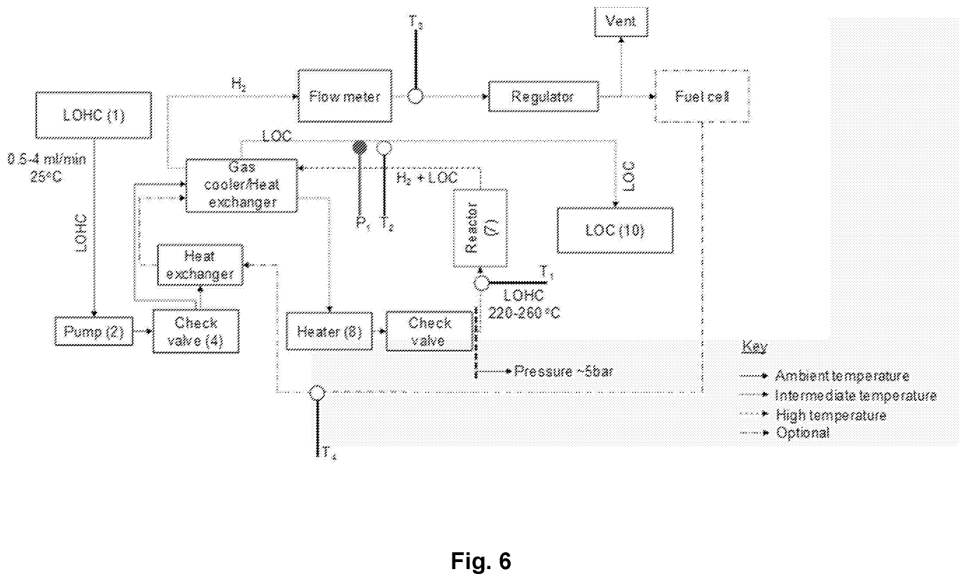

FIG. 6 schematically depicts the apparatus and the method of FIG. 5, in more detail.

FIGS. 7A to 7G are CAD perspective views of thermally conducting networks, particularly Bravais lattices, for a hydrogen storage device according to an exemplary embodiment. Dimensions of the outlining cubes are identical, for comparison. FIG. 7A shows cubic diamond lattice (face centered cubic); FIG. 7B shows a single unit cell of a body-centred cubic lattice; FIG. 7C shows cubic fluorite lattice (face centered cubic); FIG. 7D shows eight unit cells (2×2×2) of a body-centred cubic lattice, having arms of a first diameter; FIG. 7E shows eight unit cells (2×2×2) of a body-centred cubic lattice, having arms of a second diameter, greater than the first diameter; FIG. 7F shows eight unit cells (2×2×2) of a body-centred cubic lattice, having arms of a third diameter, greater than the second diameter; and FIG. 7G shows sixty four unit cells (4×4×4) of a body-centred cubic lattice, having arms of a fourth diameter, similar to the first diameter. Porosity and surface area of the thermally conducting networks increase from FIG. 7A to FIG. 7G

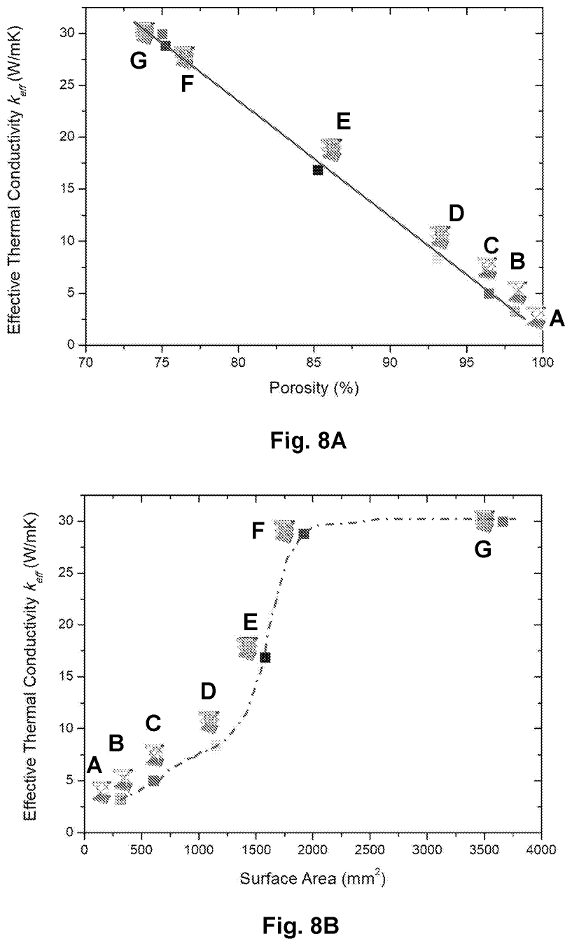

FIG. 8A is a graph of effective thermal conductivity as a function of porosity for the thermally conducting networks of FIGS. 7A to 7G; and FIG. 8B is a graph of effective thermal conductivity as a function of surface area for the thermally conducting networks of FIGS. 7A to 7G. Particularly, FIG. 8A shows that the effective thermal conductivity decreases linearly as a function of porosity. Particularly, FIG. 8B shows that the effective thermal conductivity increases as a function of surface, with a significant upwards step from D to F via E. A primary determining factor for enhanced thermal conductivity is lattice porosity. Secondary factors include surface area. Lattice G is preferred as there is a big increase in surface area for very little volume sacrifice (i.e. porosity sacrifice), compared with lattice F.

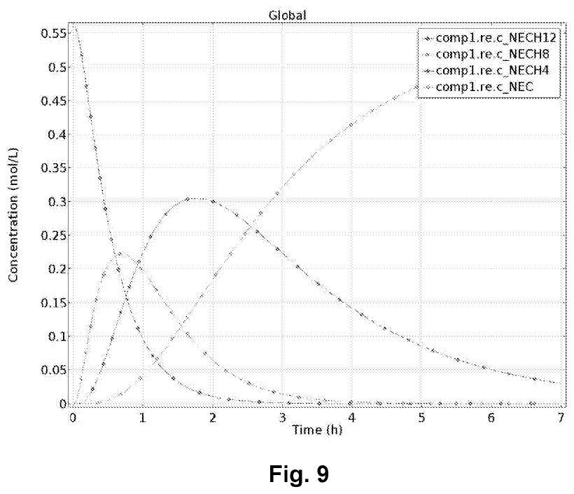

FIG. 9 is a graph of concentration of dehydrogenation products of NEC as a function of time. NECH12 undergoes a stepwise dehydrogenation according to the following reactions, producing the following species and hydrogen:

$$NECH 12 {\to }^{k 1} NECH 8 + 2 {H}_{2} \qquad ( 1 )$$

$$NECH 8 {\to }^{k 2} NECH 4 + 2 {H}_{2} \qquad ( 2 )$$

$$NECH 4 {\to }^{k 3} NEC + 2 {H}_{2} \qquad ( 3 )$$

The respective rate equations are:

$$r 1 = \frac{{dC}_{NECH 12}}{dt} = - k 1 {C}_{NECH 12} \qquad ( 4 )$$

$$r 2 = \frac{{dC}_{NECH 8}}{dt} = - k 2 {C}_{NECH 8} \qquad ( 5 )$$

$$r 3 = \frac{{dC}_{NECH 4}}{dt} = - k 1 {C}_{NECH 4} \qquad ( 6 )$$

These equations may be solved according to OD and 3D models. Data for the models were obtained from: Stark et al. (2015) Liquid organic hydrogen carriers: thermophysical and thermochemical studies of carbazole and fully hydrogenated derivatives (https://doi.org/10.1021/acs.jecr.5b01841); Mehranfar et al. (2105) N-ethyl carbazole-doped fullerene as a potential for hydrogen storage, a kinetics approach (https://doi.org/10.1039/C5RA09264G); and Wang et al. (2014) A comparative study of catalytic dehydrogenation of perhydro-N-ethylcarbazole over noble metal catalysts (https://doi.org/10.1016/j.ijhydene.2014.09.123). The experimental details from the latter were included in a OD multi component batch reaction model, including first vessel size and concentrations and temperature of 180° C. FIG. 9 shows the resulting concentrations of each species from equations (1) to (3) above. The species are successively formed before decomposing.

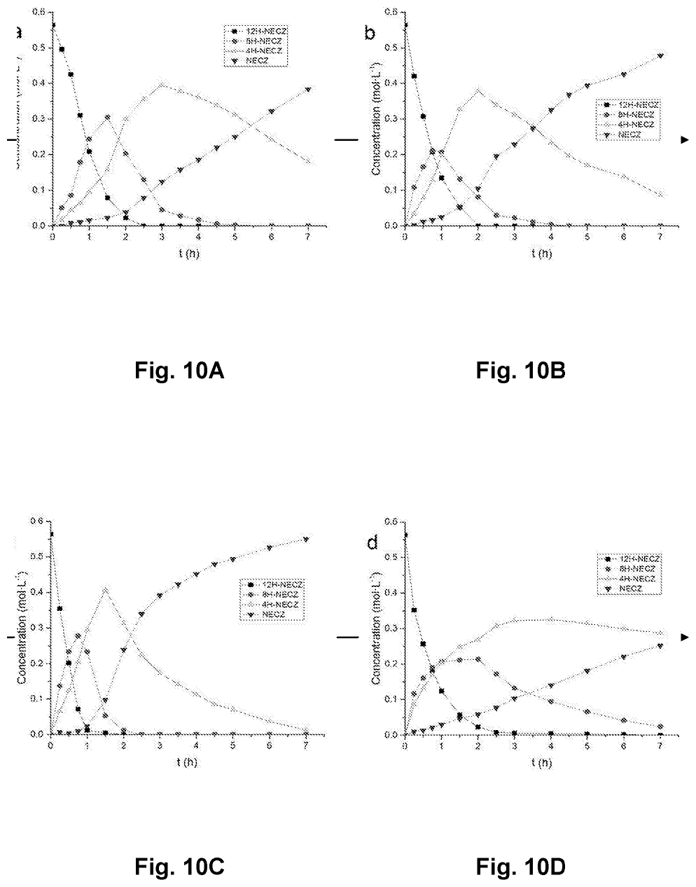

FIGS. 10A to 10D are graphs of concentration of dehydrogenation products of NEC as a function of time. Particularly, FIGS. 10A to 10D show experimental data for dehydrogenation products of NEC, catalysed by 5 wt. % of Rh, Ru, Pt and Pd, respectively, based on Wang et al. Good agreement between the model of FIG. 9 and experimental data of FIGS. 10A to 10D, particularly with respect to rates and concentrations.

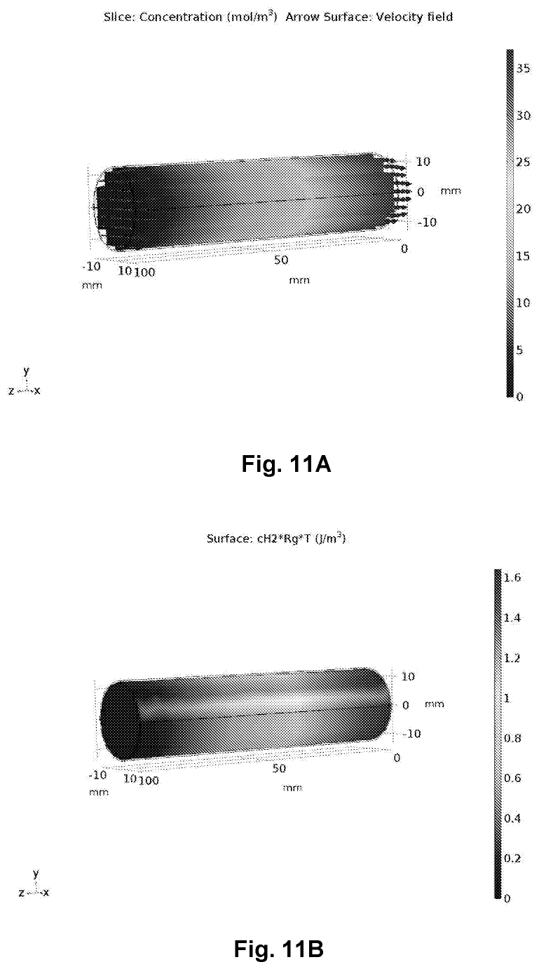

FIGS. 11A to 11B schematically depict computational fluid dynamic (CFD) modelling of dehydrogenation of a hydrogen storage material in a hydrogen storage device according to an exemplary embodiment. FIGS. 11A to 11B show end perspective views of a 3D model of dehydrogenation in a cylindrical first vessel according to an embodiment, in which the loaded LOHC flows into the first vessel from the left while LOC and hydrogen exit from the right, as shown by the arrows. The colours indicate concentration of hydrogen, with blue relatively low (left) and red relatively high (right). Particularly, FIG. 11A shows both the flux of material into and out of the system (blue arrows) and the resulting concentration of H₂. It can be seen that the concentration of H₂ starts at 0 mol m⁻³, and increases as the LOHC is heated. This behaviour is as expected. FIG. 11B shows the resulting pressure (in bar) in the first vessel as a result of H₂ generation. The concentration is used in the ideal gas law to generate hydrogen pressure. The maximum pressure calculated (1.6 bar) is in line with literature.

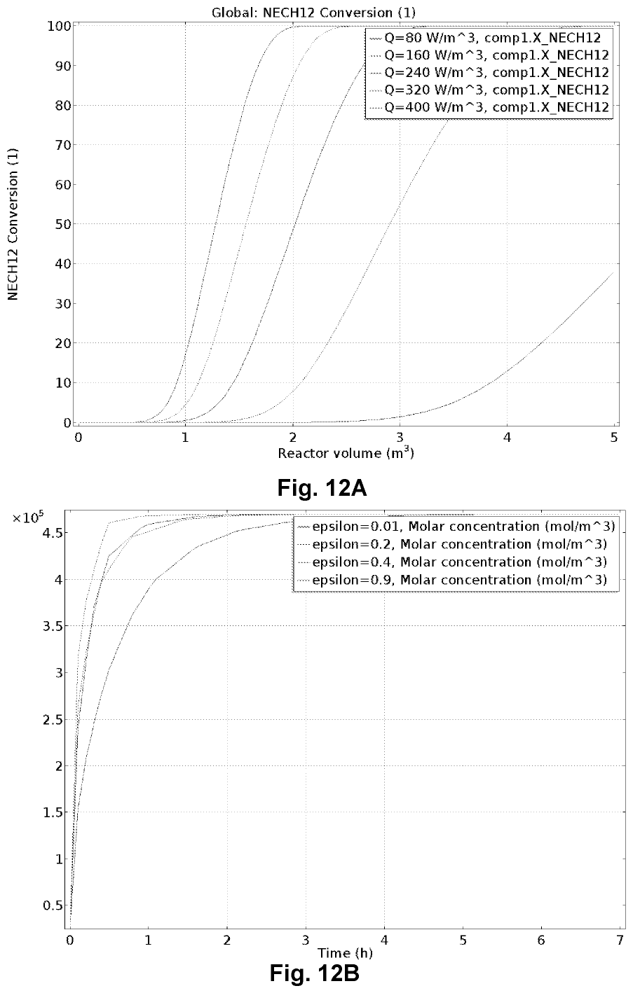

FIG. 12A is a graph of dehydrogenation of NEC-H12 as a function of first vessel volume for different heat inputs; and FIG. 12B is a graph of conversion as a function of time for different porosities of the thermally conducting network. Particularly, FIG. 12A was determined by plug flow reactor (PFR) steady state modelling, thereby modelling dehydrogenation in terms of first vessel volume and chemical conversion. A reactor volume can be determined for a desired conversion. However, this is highly dependent on inlet concentrations and flow rates. Particularly, FIG. 12B shows the effect of porosity of the thermally conducting network, determined by modelling. The porosity affects every stage of the model—from fluid flow, to temperature distribution. A sample of the energy balance equations are shown below (after https://digital.csic.es/bitstream/10261/155394/1/metal%20hydride.pdf):

$$\frac{\partial \overline{ρ {c}_{p}} T}{\partial t} + ∇ \cdot ( {ρ}^{ℊ} {c}_{p}^{ℊ} \vec{u} T ) = ∇ \cdot ( {k}^{eff} ∇ T ) + {S}_{T}$$

$${k}^{eff} = ( 1 - ε ) {k}^{m} + ε {k}^{ℊ}$$

$$\overline{ρ {c}_{p}} = ( 1 - ε ) {ρ}^{m} {c}_{p}^{m} + {ερ}^{ℊ} {c}_{p}^{ℊ}$$

$${S}_{T} = {S}_{m} [ Δ H - T ( {c}_{p}^{ℊ} - {c}_{p}^{m} ) ]$$

It can be seen that the temperature is highly dependent on c epsilon (porosity). Therefore, changing porosity changes the impact of the lattice on the model. As epsilon tends to 0, the lattice becomes less porous and as epsilon tends to 1, it becomes more porous. By changing epsilon we can understand the impact of our heat transfer network on temperature evolution and H₂ concentration. FIG. 12B shows that increasing porosity has a preferential impact on the overall conversion, shown here as the molar concertation of H₂.

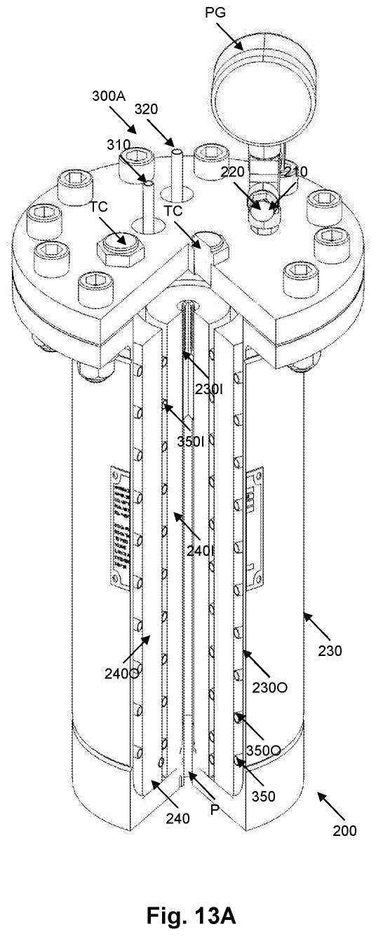

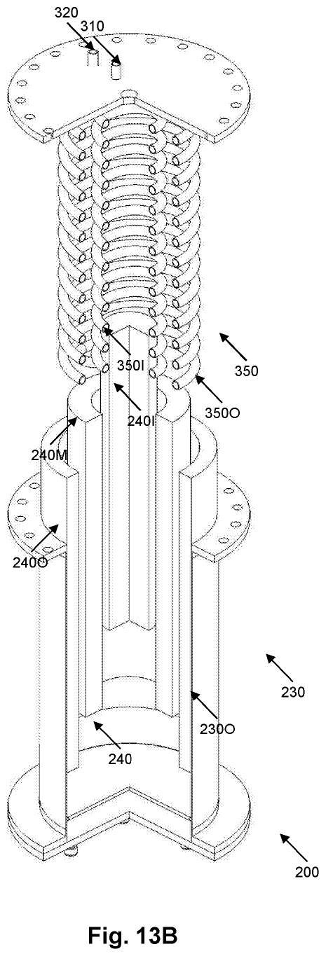

FIG. 13A is a cutaway perspective view of a hydrogen storage device 200 according to an exemplary embodiment. The hydrogen storage device 200 comprises: a first vessel 230, having a first fluid inlet 210 and a first fluid outlet 220, having therein a thermally conducting network 240 thermally coupled to a first heater (not shown); wherein the first vessel 230 is arranged to receive therein a hydrogen storage material in thermal contact, at least in part, with the thermally conducting network 240; wherein the thermally conducting network 240 has a lattice geometry in three dimensions, comprising a plurality of nodes, having thermally conducting arms therebetween, with voids between the arms; and wherein the hydrogen storage material comprises and/or is a liquid organic hydrogen carrier, LOHC. In this example, the hydrogen storage device 200 is a static hydrogen storage device 200.

In this example, the vessel 230 is generally cylindrical, having a generally internally dished first end and a flanged second end opposed thereto, and having a single aperture providing both the first fluid inlet 210 and the first fluid outlet 220. In other words, the vessel 230 is can-shaped. An inner wall portion 230I of the vessel 230 provides an axial cylindrical, elongate blind passageway P, arranged to optionally receive a second heater 300B (not shown) of the set of heaters 300, particularly a cartridge heater (not shown), that extends from the first end towards the second end and that is coaxial with an outer wall portion 230O of the vessel 230. Blind passageways in the second end are arranged to receive thermocouples TC. In this example, the first heater 300A is provided by a recirculating heater, for example heated using waste heat from a fuel cell coupled thereto, and includes a double helix heating tube 350, having an inlet 310 and an outlet 320, in thermal contact with the thermally conducting network 20, which is arranged between the inner 350I and outer 350O helices of the heating tube 350. The double helix heating tube 350 extends from the second end towards the first end is coaxial with an outer wall portion 230O of the vessel 230. The inner 350I and outer 350O helices of the double helix heating tube 350 are directly in thermal contact with the inner wall portion 230I and the outer wall portion 230O of the vessel 230, respectively. A pressure gauge PG is provided in the second end. The second end is mechanically releasably coupled to the vessel 230, using mechanical fasteners.

In this example, the thermally conducting network 240 has a lattice geometry in three dimensions, in which generally each node is connected by four arms to four other nodes, respectively, in an axially adjacent preceding layer, such that generally each node is thus connected by eight arms to eight other nodes, four nodes in the axially adjacent preceding layer and four nodes in an axially adjacent proceeding layer. Nodes proximal the inner 350I and outer 350O helices of the heating tube 350 are in mutual thermal contact therewith. In this example, an effective density of the lattice geometry is uniform in a first dimension, particularly axially, and non-uniform in mutually orthogonal second and third dimensions, particularly radially. In this example, the thermally conducting network 240 has a porosity of at least 90%. In this example, the thermally conducting network 240 is formed from an aluminium alloy. In this example, the thermally conducting network 240 comprises inner 240I and outer 240O portions, having annular shapes. The outer portion 240O is received in thermal contact with and between the inner 350I and outer 350O helices of the double helix heating tube 350 while the inner portion 240I is received in thermal contact with and within the inner helix 350I.

FIG. 13B is a cutaway perspective exploded view of a related hydrogen storage device 200. In contrast with the hydrogen storage device 200 of FIG. 13A, the thermally conducting network 240 of the hydrogen storage device 200 of FIG. 13B comprises inner 240I, middle 240M and outer 240O portions. The inner portion 240I has a cylindrical shape and the middle 240M and outer 240O portions have annular shapes. The outer portion 240O is received in thermal contact and without the outer 350O helices of the double helix heating tube 350, the middle portion 240M is received in thermal contact with and between the inner 350I and outer 350O helices while the inner portion 240I is received in thermal contact with and within the inner helix 350I.

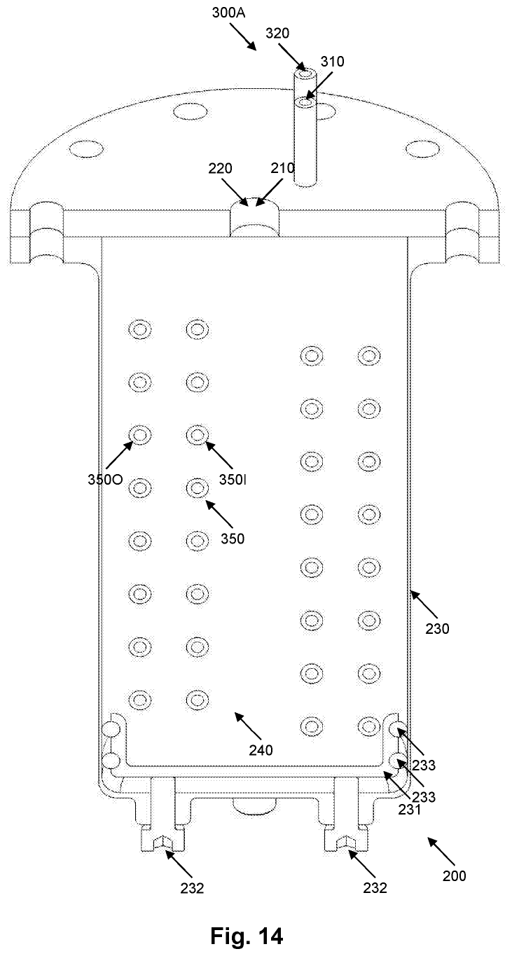

FIG. 14 is a cutaway perspective view of a hydrogen storage device according to an exemplary embodiment. The hydrogen storage device 200 is generally as described with respect to the hydrogen storage devices 200 of FIGS. 13A and 13B and like reference signs denote like features.

In contrast with the hydrogen storage device 200 of FIGS. 13A and 13B, the hydrogen storage device 200 does not include the inner wall portion 230I of the vessel 230 of FIGS. 13A and 13B and does not include blind passageways in the second end to receive thermocouples. In contrast with the hydrogen storage device 200 of FIGS. 13A and 13B, the thermally conducting network 240 is cylindrical, to be received in thermal contact with the outer wall portion 230O of the vessel 230. In contrast with the hydrogen storage device 200 of FIGS. 13A and 13B, the inner 350I and outer 350O helices of the double helix heating tube 350 are integrated within the thermally conducting network 240. Hence, the inner 350I and outer 350O helices of the double helix heating tube 350 are mutually spaced apart from and only indirectly in thermal contact with the outer wall portion 230O of the vessel 230, respectively, via the thermally conducting network 240. In this example, the hydrogen storage device 200 includes a bed compression disc 231, internal to the vessel 230 proximal the first end and bed compression disc bolts 232 mechanically coupled thereto, extending through the first end, for uniaxially compressing the hydrogen storage material to improve thermal contact with the thermally conducting network. O-rings 233 are arranged in the outer wall portion 230O to prevent loss of the hydrogen storage material during compression thereof.

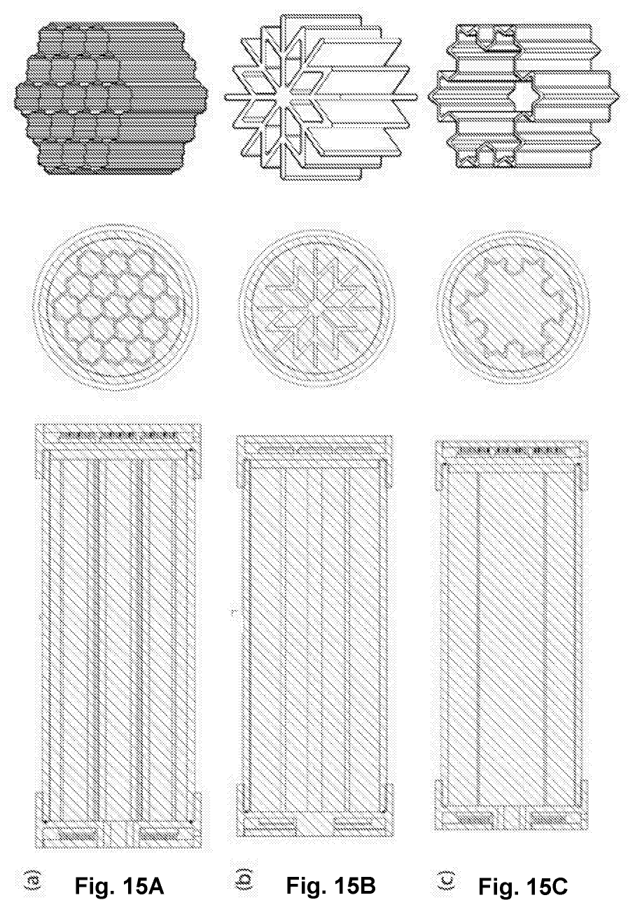

FIGS. 15A to 15C schematically depict thermally conducting networks for a hydrogen storage device according to an exemplary embodiment. Particularly, FIG. 15 shows three alternative fractal networks (A) Gosper Island; (B) ‘Snowflake’ design; and (C) Koch Snowflake for the thermally conducting network of the hydrogen storage device 200. The 2D radially symmetric fractal patterns extend axially. Axial cross-sections, midpoint radial cross-sections and perspective views for the fractal networks are shown.

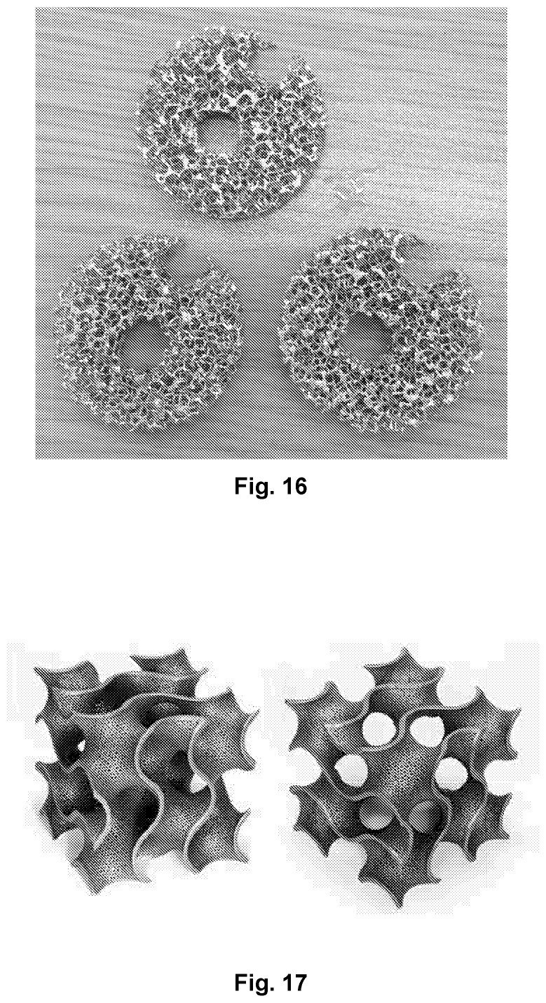

FIG. 16 is a photograph of a foam for a hydrogen storage device according to an exemplary embodiment. FIG. 16 shows a photograph of voids (i.e. open space) in a metal foam, particularly aluminium foam. The aluminium foam is produced from 6101 aluminium alloy, retaining 99% purity of the parent alloy. The foam has a reticulated structure in which cells (i.e. pores) are open and have a dodecahedral shape. The foam has a bulk density of 0.2 gcm⁻³; a porosity of 93% porosity and about 8 pores/cm.

FIG. 17 is a CAD cutaway perspective view of a thermally conducting network for a hydrogen storage device according to an exemplary embodiment. Particularly, the thermally conducting network is gyroidal.

FIG. 18A is a CAD cutaway perspective view of a hydrogen storage device 200′″ according to an exemplary embodiment; FIG. 18B is a CAD axial cross-section perspective view of the hydrogen storage device 200′″; and FIG. 18C is a CAD perspective view of the thermally conducting network of the hydrogen storage device 200′″. In this example, the first vessel 201′″ has an internal volume of about 50 cm³, thereby providing a hydrogen storage capacity of about 2.5 g H₂. FIG. 18C is a CAD radial cross-section of a thermally conducting network of the hydrogen storage device of FIG. 12. Generally, the lattice geometry is as described with respect to FIG. 1C.

In more detail, in this example, the hydrogen storage device 200′″ comprises: a first vessel 201″, having a first fluid inlet 208′″ and/or a first fluid outlet 209′″, having therein a thermally conducting network 204′″ thermally coupled to a first heater (not shown); wherein the first vessel 201′″ is arranged to receive therein a hydrogen storage material in thermal contact, at least in part, with the thermally conducting network 204′″; wherein the thermally conducting network 203′″ has a lattice geometry in three dimensions, comprising a plurality of nodes, having thermally conducting arms therebetween, with voids between the arms; and; and wherein the hydrogen storage material comprises and/or is a liquid organic hydrogen carrier, LOHC.

In this example, the first vessel 201′″ is generally cylindrical, having a generally flat first end and a necked second end opposed thereto, and having a single aperture providing both the first fluid inlet 208′″ and the first fluid outlet 209′″. In other words, the first vessel 201″ is bottle-shaped. An inner wall portion 201I″ of the first vessel 201″ provides an axial cylindrical, elongate blind passageway 210′″, arranged to receive a first heater 206′″ (not shown), that extends from the first end towards the second end and that is coaxial with an outer wall portion 201O″ of the first vessel 201′″. A second blind passageway in the first end is arranged to receive a thermocouple (not shown).

In this example, the thermally conducting network 204′″ has a lattice geometry in three dimensions. In this example, an effective density of the lattice geometry is uniform in a first dimension, particularly axially, and non-uniform in mutually orthogonal second and third dimensions, particularly radially. Particularly, the effective density decreases radially outwards, such that there is faster heat transfer proximal the passageway 210′″ and hence the first heater. In this example, the thermally conducting network 204′″ is formed from an aluminium alloy. Alternatively, the thermally conducting network 204′″ may be formed from copper, respective alloys thereof such as brass or bronze alloys, and/or stainless steel, as described previously.

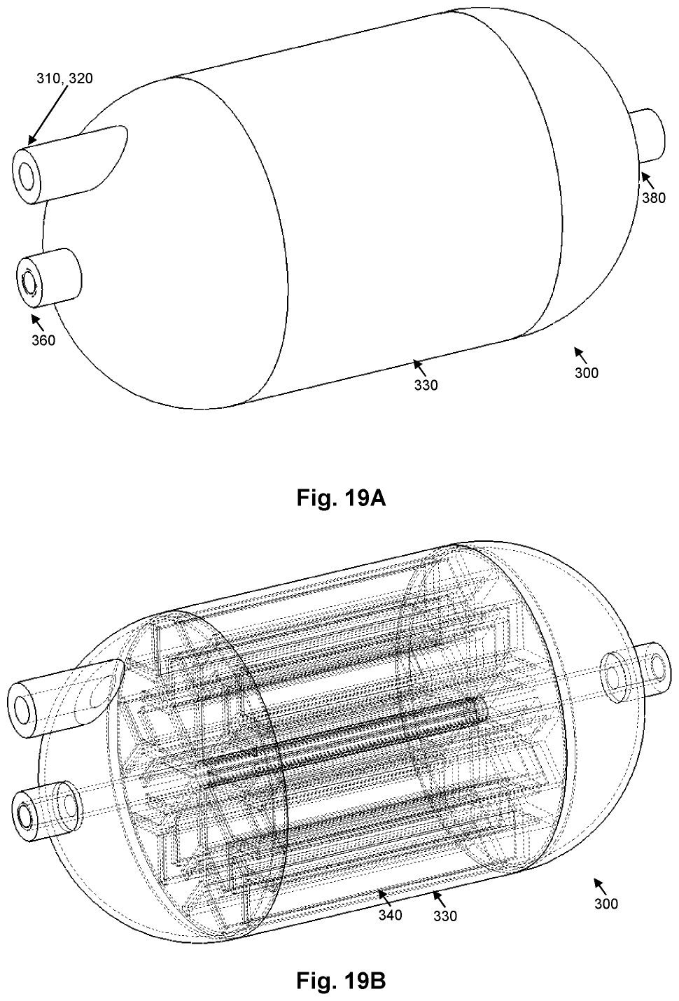

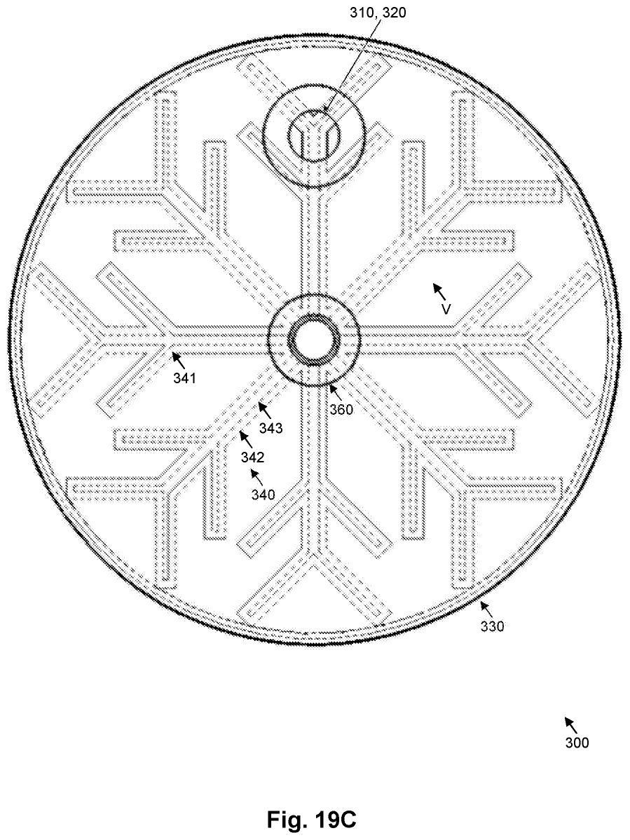

FIG. 19A is a CAD perspective view of a hydrogen storage device 300 according to an exemplary embodiment; FIG. 19B is a CAD perspective semi-transparent view of the hydrogen storage device 300 of FIG. 19A; and FIG. 19C is a CAD axial cross-section view of the hydrogen storage device 300 of FIG. 19A.

In this example, the hydrogen storage device 300 comprises: a first vessel 330, having a first fluid inlet 310 and/or a first fluid outlet 320, having therein a thermally conducting network 340 optionally thermally coupled to a first heater and/or a first cooler; wherein the first vessel 330 is arranged to receive therein a hydrogen storage material in thermal contact, at least in part, with the thermally conducting network 340; wherein the thermally conducting network 340 has a fractal geometry in two dimensions, comprising a plurality of nodes 341, having thermally conducting arms 342 therebetween, with voids V between the arms 342; and wherein the hydrogen storage material comprises and/or is a liquid organic hydrogen carrier, LOHC. In this example, the thermally conducting network 340 comprises fluidically interconnected passageways 343 therein, within the arms 342 and the nodes 341 thereof, for flow therethough of a fluid. In this example, the first vessel 330 is generally cylindrical, having dished ends. In this example, a passageway 350, provided by a tube having a circular cross-section, extends between the dished ends longitudinally. In this example, the thermally conducting network 240 partially fills an internal volume of the first vessel 330. In this example, the thermally conducting network 240B is thermally coupled to at least a part of an internal surface of the first vessel 230B and an external surface of the tube.

### Alternatives

Although a preferred embodiment has been shown and described, it will be appreciated by those skilled in the art that various changes and modifications might be made without departing from the scope of the invention, as defined in the appended claims and as described above.

### Summary

In summary, the invention provides a hydrogen storage device comprising: a first vessel, having a first fluid inlet and/or a first fluid outlet, having therein a thermally conducting network thermally coupled to a first heater; wherein the first vessel is arranged to receive therein a hydrogen storage material in thermal contact, at least in part, with the thermally conducting network; wherein the thermally conducting network has a lattice geometry, a gyroidal geometry and/or a fractal geometry in two and/or three dimensions, comprising a plurality of nodes, having thermally conducting arms therebetween, with voids between the arms; and wherein the hydrogen storage material comprises and/or is a liquid organic hydrogen carrier, LOHC.

In this way, control for charging and/or release (also known as loading and unloading, respectively) of hydrogen from the hydrogen storage material is improved because the flow of heat through the thermally conducting network provides for faster, more homogenous, more accurate and/or more precise heating and cooling of the hydrogen storage material in thermal contact therewith. In this way, release of hydrogen is with less delay or lag time, thereby providing hydrogen more responsively, for example in response to a demand. Conversely, storage of hydrogen is more efficient, allowing faster mass or volume flow of the hydrogen storage material through the hydrogen storage device.

### DISCLOSURE

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A hydrogen storage device comprising:
a first vessel, having a first fluid inlet and/or a first fluid outlet, having therein a thermally conducting network thermally coupled to a first heater;
wherein the first vessel is arranged to receive therein a hydrogen storage material in thermal contact, at least in part, with the thermally conducting network;
wherein the thermally conducting network has a lattice geometry, a gyroidal geometry and/or a fractal geometry in two and/or three dimensions, comprising a plurality of nodes, having thermally conducting arms therebetween, with voids between the arms;
wherein the hydrogen storage material comprises and/or is a liquid organic hydrogen carrier (LOHC); and
wherein the thermally conducting network comprises a LOHC hydrogenation and/or dehydrogenation catalyst provided on and/or in a surface thereof.

2. The hydrogen storage device according to claim 1, wherein the hydrogen storage device is arrangeable in:
a first arrangement wherein the thermally conducting network is within the first vessel; and
a second arrangement wherein the thermally conducting network is outside the first vessel;
wherein the first vessel comprises a circumferential releasable joint.

3. The hydrogen storage device according to claim 1, wherein the thermally conducting network comprises fluidically interconnected passageways within the arms and/or the nodes thereof, for flow therethough of a fluid.

4. The hydrogen storage device according to claim 1, wherein the thermally conducting network comprises a LOHC hydrogenation and/or dehydrogenation catalyst, provided on and/or in a surface thereof.

5. The hydrogen storage device according to claim 1, wherein the thermally conducting network has a porosity in a range from 50% to 99% by volume of the thermally conducting network.

6. The hydrogen storage device according to claim 1, wherein the thermally conducting network has a specific surface area in a range from 0.1 m⁻¹ to 100 m⁻¹.

7. The hydrogen storage device according to claim 1, wherein the first heater is arranged to provide a heat output in a range from 0.1 MW m⁻³ to 50 MW m⁻³, preferably in a range from 1 MW m⁻³ to 25 MW m⁻³, more preferably in a range from 2.5 MW m⁻³ to 10 MW m⁻³.

8. The hydrogen storage device according to claim 1, wherein the first heater is arranged heat the hydrogen storage material to temperature in a range from 50° C. to 400° C.

9. The hydrogen storage device according to claim 1, comprising a pump arranged to flow the hydrogen storage material through the first vessel.

10. The hydrogen storage device according to claim 1, wherein the LOHC comprises and/or is a saturated cycloalkene, aromatic, heterocyclic aromatic and/or a mixture thereof.

11. The hydrogen storage device according to claim 1, wherein the LOHC comprises and/or is a compound selected from a group consisting of: N-ethylcarbazole (NEC), monobenzyltoluene (MBT), dibenzyltoluene (DBT), 1,2-dihydro-1,2-azaborine (AB), toluene (TOL), naphthalene (NAP), benzene, phenanthrene, pyrene, pyridine, chinoline, flurene, carbazole, methanol, formic acid, phenazine, ammonia, and mixtures thereof.

12. The hydrogen storage device according to claim 1, wherein the hydrogen storage material comprises a dopant, is provided in a solvent, or both.

13. The hydrogen storage device according to claim 1, having a hydrogen storage density of at least 0.01 wt. % of the hydrogen storage material.

14. The hydrogen storage device according to claim 1, wherein the fractal geometry is selected from a group consisting of: a Quadratic Koch Island, a Quadratic Koch surface, a Von Koch surface, a Koch Snowflake, a Sierpinski carpet, a Sierpinski tetrahedron, a Mandelbox, a Mandelbulb, a Dodecahedron fractal, a Icosahedron fractal, a Octahedron fractal, a Menger sponge, a Jerusalem cube, and a 3D H-fractal.

15. The hydrogen storage device according to claim 1, wherein an effective density of the lattice geometry is uniform in a first dimension and non-uniform in mutually orthogonal second and third dimensions.

16. The hydrogen storage device according to claim 1, wherein the lattice geometry is Bravais lattice; a monoclinic lattice; an orthorhombic lattice; a tetragonal lattice; a hexagonal lattice; or a cubic lattice.

17. The hydrogen storage device according to claim 1, wherein the thermally conducting arms have a cross sectional dimension in a range from 0.1 mm to 10 mm.

18. The hydrogen storage device according to claim 1, wherein the thermally conducting network is formed, at least in part, by additive manufacturing and/or by casting.

19. The hydrogen storage device according to claim 1, comprising a thermally-conducting foam attached and/or attachable to the thermally conducting network.

20. The hydrogen storage device according to claim 1, wherein the thermally conducting network partially fills an internal volume of the first vessel, of at least 50% by volume of the first vessel, thereby defining an unfilled volume.

21. The hydrogen storage device according to claim 1, wherein the first heater comprises a Joule heater, a recirculating heater and/or a hydrogen catalytic combustor and the hydrogen storage device is arranged to interchangeably receive the Joule heater and the recirculating heater therein and/or thereon.

22. The hydrogen storage device according to claim 1, wherein the hydrogen storage device comprises a heat exchanger configured to exchange heat from and/or to the LOHC.

23. The hydrogen storage device according to claim 1, wherein the hydrogen storage device comprises thermal insulation, configured to thermally insulate the first vessel.

24. The hydrogen storage device according to claim 1, wherein the first vessel comprises a set of expansion tanks, including a first expansion tank and a second expansion tank, wherein the first expansion tank and the second expansion tank are mutually fluidically coupled.

25. A method of storing hydrogen comprising passing hydrogen gas into a hydrogen storage device according to claim 1, comprising heating the thermally conducting network using the first heater.

26. A method of providing hydrogen comprising releasing hydrogen gas from a hydrogen storage device according to claim 1, comprising heating the thermally conducting network using the first heater.
